(19) United States
(12) Patent Application Publication
(10) Pub. No.: US 2017/0217166 A1
(43) Pub. Date: Aug. 3, 2017

(54) LIQUID EJECTION DEVICE, METHOD OF MANUFACTURING LIQUID EJECTION DEVICE, AND PRINTER

(71) Applicant: CANON KABUSHIKI KAISHA, Tokyo (JP)

(72) Inventors: Norihiko Ochi, Kawasaki-shi (JP); Koji Kitani, Chofu-shi (JP)

(21) Appl. No.: 15/502,307

(22) PCT Filed: Sep. 8, 2015
(86) PCT No.: PCT/JP2015/004553

§ 371 Date: Feb. 7, 2017

(30) Foreign Application Priority Data
Sep. 11, 2014 (JP) 2014-184808

(51) Int. Cl. B41J 2/14; B41J 2/16

(52) U.S. Cl. CPC B41J 2/14; B41J 2/16

(57) ABSTRACT

Provided is a liquid ejection device capable of ejecting a minute liquid droplet with stability, in which a capacity of a pressure chamber facing a second partition portion increases, and a capacity of the pressure chamber facing a first partition portion decreases, at a time when a voltage is applied so that a potential of a first electrode becomes lower than a potential of a second electrode, compared to a time when a voltage is applied so that the potential of the first electrode becomes the same as the potential of the second electrode, the first electrode and the second electrode being included in an electrode formed on each of both side surfaces of partitions.

### TECHNICAL FIELD

The present invention relates to a liquid ejection device, a method of manufacturing a liquid ejection device, and a printer.

### BACKGROUND ART

A liquid ejection device (liquid ejection head) is configured to change liquid pressure in a region filled with liquid (pressure chamber) to eject liquid from a discharge port. A drop-on-demand liquid ejection device is most generally widespread. Further, systems for applying pressure to liquid are broadly divided into two systems. One of the systems is a system in which a capacity of the pressure chamber is changed by applying a drive signal to a piezoelectric element to displace the piezoelectric element, to thereby apply pressure to liquid. The other of the systems is a system in which a resistor produces heat by a drive signal applied to the resistor to generate an air bubble in the pressure chamber, to thereby apply pressure to liquid.

The liquid ejection device using the piezoelectric element can be manufactured relatively easily by mechanically processing a bulk piezoelectric material. Further, the liquid ejection device using the piezoelectric element is also advantageous in that there are few restrictions imposed on a kind of liquid and that liquid containing various materials can be ejected. From such a viewpoint, in recent years, there is an increase in attempts to use the liquid ejection device using the piezoelectric element for an industrial purpose such as manufacture of a color filter or formation of wiring.

Further, a technology involving changing a capacity of a pressure chamber (liquid channel) by displacing a partition formed of a piezoelectric material in a shear mode, to thereby eject liquid, can precisely control the capacity change of the pressure chamber, and thus has attracted great attention (Patent Literature 1).

Further, in recent years, there is a demand to eject a minute liquid droplet. For example, liquid ejection on the order of picoliters is required. Further, liquid ejection even on the order of subpicoliters or smaller is required.

### CITATION LIST

### Patent Literature

PTL 1: Japanese Examined Patent Publication No. H06-6375
PTL 2: Japanese Patent Application Laid-Open No. 2003-165220
PTL 3: Japanese Patent Application Laid-Open No. 2007-38654

### SUMMARY OF INVENTION

### Technical Problem

However, it is not necessarily easy to eject a minute liquid droplet with stability.

It is an object of the present invention to provide a liquid ejection device capable of ejecting a minute liquid droplet with stability.

### Solution to Problem

According to one aspect of an embodiment, a liquid ejection device, including: a base including: a first piezoelectric member; and a second piezoelectric member fixed to the first piezoelectric member and polarized in a direction opposite to a polarization direction of the first piezoelectric member; a pressure chamber formed to the base and separated by at least two partitions formed of the first piezoelectric member and the second piezoelectric member; and an electrode formed on each of both side surfaces of the at least two partitions, wherein: the pressure chamber is narrow on a front surface side on which a discharge port configured to eject liquid is formed; a surface of the at least two partitions that faces the pressure chamber includes: a first partition portion formed of only the first piezoelectric member; and a second partition portion formed of the first piezoelectric member and the second piezoelectric member; the pressure chamber is separated by the first partition portion on the front surface side; the pressure chamber is separated by the second partition portion on a back surface side on which a liquid chamber configured to supply the liquid to the pressure chamber is formed; the electrode formed on each of the both side surfaces of the at least two partitions includes a first electrode on the pressure chamber side and a second electrode on a side opposite to the pressure chamber side; and a capacity of the pressure chamber facing the second partition portion increases, and a capacity of the pressure chamber facing the first partition portion decreases, at a time when a voltage is applied so that a potential of the first electrode becomes lower than a potential of the second electrode, compared to a time when a voltage is applied so that the potential of the first electrode becomes the same as the potential of the second electrode.

According to another aspect of the embodiment, a liquid ejection device, including: a base including: a first piezoelectric member; and a second piezoelectric member fixed to the first piezoelectric member and polarized in a direction opposite to a polarization direction of the first piezoelectric member; a pressure chamber formed to the base and separated by at least two partitions formed of the first piezoelectric member and the second piezoelectric member and by a plate mounted on end surfaces of the at least two partitions; and an electrode formed on each of both side surfaces of the at least two partitions, wherein: the pressure chamber is narrow on a front surface side on which a discharge port configured to eject liquid is formed; a surface of the at least two partitions that faces the pressure chamber includes: a first partition portion formed of only the first piezoelectric member; and a second partition portion formed of the first piezoelectric member and the second piezoelectric member; the pressure chamber is separated by the first partition portion on the front surface side; the pressure chamber is separated by the second partition portion on a back surface side on which a liquid chamber configured to supply the liquid to the pressure chamber is formed; and the electrode formed on at least one side surface of the first partition portion is formed within a range other than a predetermined range from the end surface.

According to further another aspect of the embodiment, a method of manufacturing a liquid ejection device, including: forming a groove in a first piezoelectric member and a second piezoelectric member fixed to the first piezoelectric member and polarized in a direction opposite to a polarization direction of the first piezoelectric member, to thereby form a pressure chamber separated by a partition including a first partition portion obtained by cutting up to the first piezoelectric member and a second partition portion obtained by cutting from the first piezoelectric member up to the second piezoelectric member; forming an electrode on the partition; and removing the electrode formed on at least one side surface of the first partition portion and formed within a predetermined range from an end surface of the partition.

According to further another aspect of the embodiment, a printer, including the above mentioned liquid ejection device.

Further features of the present invention will become apparent from the following description of exemplary embodiments with reference to the attached drawings.

### BRIEF DESCRIPTION OF DRAWINGS

FIG. 1 is an exploded perspective view for schematically illustrating a liquid ejection device according to an embodiment of the present invention.

FIG. 2 is a sectional view for illustrating a part of a piezoelectric transducer of the liquid ejection device according to the embodiment of the present invention.

FIG. 3 is a perspective view for illustrating a part of the piezoelectric transducer of the liquid ejection device according to the embodiment of the present invention.

FIG. 4 is a perspective view for illustrating a part of the piezoelectric transducer of the liquid ejection device according to the embodiment of the present invention.

FIG. 5A is a sectional view for illustrating a part of the piezoelectric transducer of the liquid ejection device according to the embodiment of the present invention.

FIG. 5B is a sectional view for illustrating a part of the piezoelectric transducer of the liquid ejection device according to the embodiment of the present invention.

FIG. 6A is a sectional view for illustrating a part of the piezoelectric transducer of the liquid ejection device according to the embodiment of the present invention.

FIG. 6B is a sectional view for illustrating a part of the piezoelectric transducer of the liquid ejection device according to the embodiment of the present invention.

FIG. 7A is a perspective view for illustrating a part of the piezoelectric transducer of the liquid ejection device according to the embodiment of the present invention.

FIG. 7B is a perspective view for illustrating a part of the piezoelectric transducer of the liquid ejection device according to the embodiment of the present invention.

FIG. 8A is a sectional view for illustrating displacement of a partition of the piezoelectric transducer of the liquid ejection device according to the embodiment of the present invention.

FIG. 8B is a sectional view for illustrating the displacement of a partition of the piezoelectric transducer of the liquid ejection device according to the embodiment of the present invention.

FIG. 9A is a sectional view for illustrating the displacement of the partition of the piezoelectric transducer of the liquid ejection device according to the embodiment of the present invention.

FIG. 9B is a sectional view for illustrating the displacement of the partition of the piezoelectric transducer of the liquid ejection device according to the embodiment of the present invention.

FIG. 10A is a sectional view for illustrating the displacement of the partition of the piezoelectric transducer of the liquid ejection device according to the embodiment of the present invention.

FIG. 10B is a sectional view for illustrating the displacement of the partition of the piezoelectric transducer of the liquid ejection device according to the embodiment of the present invention.

FIG. 11A is a sectional view for illustrating an operation of the piezoelectric transducer of the liquid ejection device according to the embodiment of the present invention.

FIG. 11B is a sectional view for illustrating an operation of the piezoelectric transducer of the liquid ejection device according to the embodiment of the present invention.

FIG. 11C is a sectional view for illustrating an operation of the piezoelectric transducer of the liquid ejection device according to the embodiment of the present invention.

FIG. 11D is a sectional view for illustrating an operation of the piezoelectric transducer of the liquid ejection device according to the embodiment of the present invention.

FIG. 11E is a sectional view for illustrating an operation of the piezoelectric transducer of the liquid ejection device according to the embodiment of the present invention.

FIG. 12 is a process view for illustrating a method of manufacturing a liquid ejection device according to the embodiment of the present invention.

FIG. 13 is a process view for illustrating the method of manufacturing a liquid ejection device according to the embodiment of the present invention.

FIG. 14 is a process view for illustrating the method of manufacturing a liquid ejection device according to the embodiment of the present invention.

FIG. 15 is a process view for illustrating the method of manufacturing a liquid ejection device according to the embodiment of the present invention.

FIG. 16A is a process view for illustrating a method of manufacturing a liquid ejection device according to the embodiment of the present invention and Modification Example (Part 3) of the embodiment of the present invention.

FIG. 16B is a process view for illustrating a method of manufacturing a liquid ejection device according to Modification Example (Part 1) and Modification Example (Part 4) of the embodiment of the present invention.

FIG. 16C is a process view for illustrating a method of manufacturing a liquid ejection device according to Modification Example (Part 2) and Modification Example (Part 5) of the embodiment of the present invention.

FIG. 17 is a process view for illustrating the method of manufacturing a liquid ejection device according to the embodiment of the present invention.

FIG. 18A is a sectional view for illustrating a parts of a piezoelectric transducer of the liquid ejection device according to Modification Example (Part 1) of the embodiment of the present invention.

FIG. 18B is a sectional view for illustrating a parts of a piezoelectric transducer of the liquid ejection device according to Modification Example (Part 1) of the embodiment of the present invention.

FIG. 19A is a sectional view for illustrating a part of a piezoelectric transducer of the liquid ejection device according to Modification Example (Part 2) of the embodiment of the present invention.

FIG. 19B is a sectional view for illustrating a part of a piezoelectric transducer of the liquid ejection device according to Modification Example (Part 2) of the embodiment of the present invention.

FIG. 20A is a sectional view for illustrating a part of a piezoelectric transducer of the liquid ejection device according to Modification Example (Part 3) of the embodiment of the present invention.

FIG. 20B is a sectional view for illustrating a part of a piezoelectric transducer of the liquid ejection device according to Modification Example (Part 3) of the embodiment of the present invention.

FIG. 21A is a sectional view for illustrating a part of a piezoelectric transducer of the liquid ejection device according to Modification Example (Part 4) of the embodiment of the present invention.

FIG. 21B is a sectional view for illustrating a part of a piezoelectric transducer of the liquid ejection device according to Modification Example (Part 4) of the embodiment of the present invention.

FIG. 22A is a sectional view for illustrating a part of a piezoelectric transducer of the liquid ejection device according to Modification Example (Part 5) of the embodiment of the present invention.

FIG. 22B is a sectional view for illustrating a part of a piezoelectric transducer of the liquid ejection device according to Modification Example (Part 5) of the embodiment of the present invention.

FIG. 23 is a perspective view for illustrating a part of the piezoelectric transducer of the liquid ejection device according to the embodiment of the present invention.

FIG. 24A is a perspective view for illustrating a part of a piezoelectric transducer of a liquid ejection device according to Example 1 and Example 5.

FIG. 24B is a perspective view for illustrating a part of a piezoelectric transducer of a liquid ejection device according to Example 2.

FIG. 24C is a perspective view for illustrating a part of a piezoelectric transducer of a liquid ejection device according to Example 3.

FIG. 24D is a perspective view for illustrating a part of a piezoelectric transducer of a liquid ejection device according to Example 4 and Example 6.

### DESCRIPTION OF EMBODIMENTS

When a speed of a liquid droplet to be ejected becomes equal to or higher than a given speed, a minute liquid droplet separate from a main droplet (main liquid droplet) is unintentionally generated before the main droplet. Such a minute liquid droplet as to be generated separately from the main droplet is referred to as “satellite droplet”.

In general, in liquid ejection, the liquid is ejected while a liquid ejection device is being moved relatively to a target on which the liquid droplet is to land. Therefore, after a satellite droplet is generated, the satellite droplet lands in a position different from a landed position of the main droplet. The generation of the satellite droplet causes a pattern failure and the like.

Preferred embodiments of the present invention will now be described in detail in accordance with the accompanying drawings.

### Embodiment

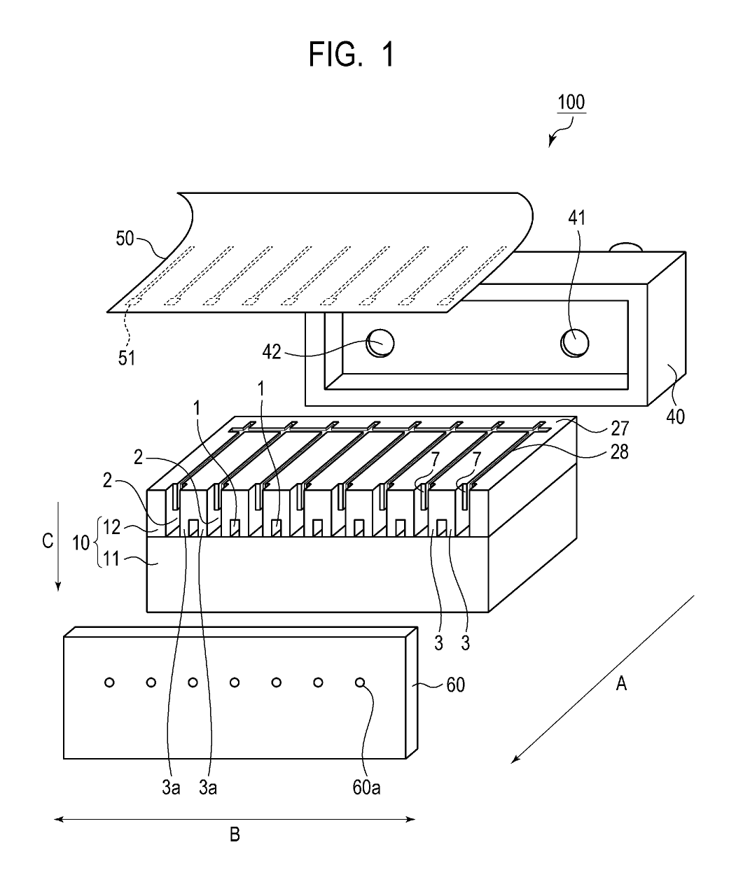

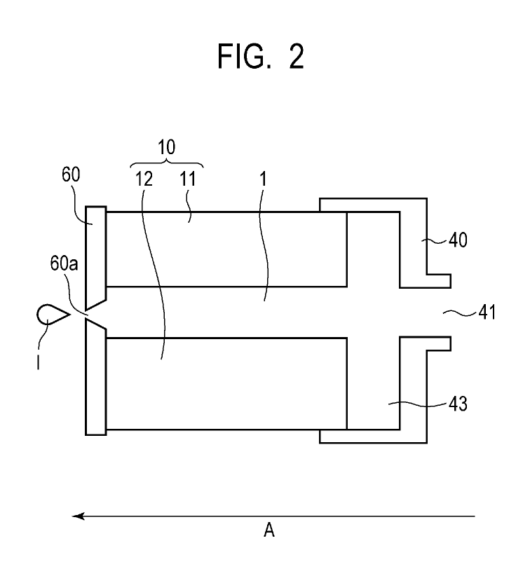

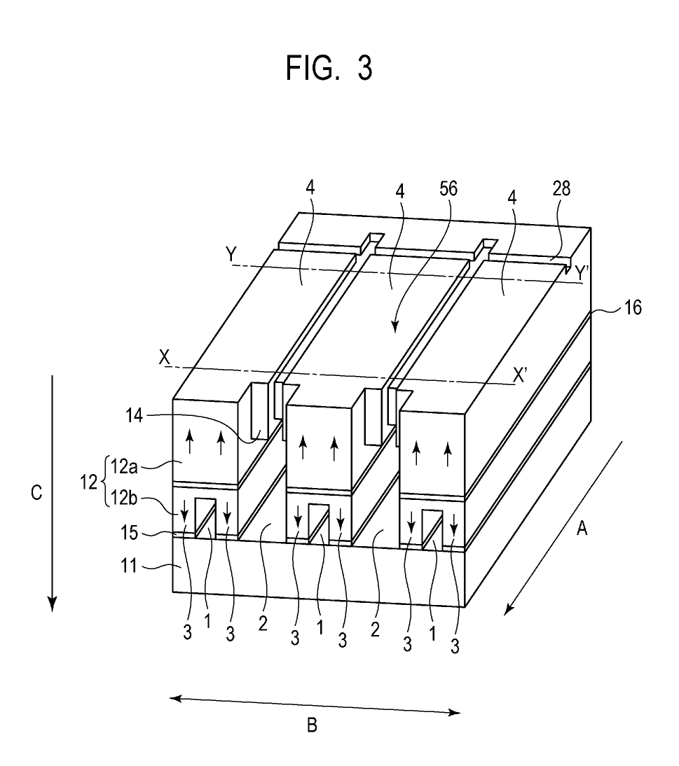

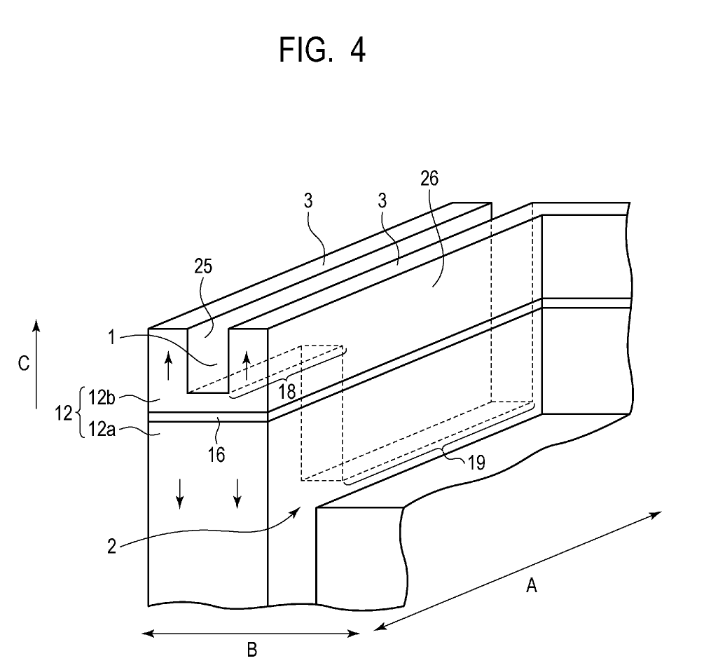

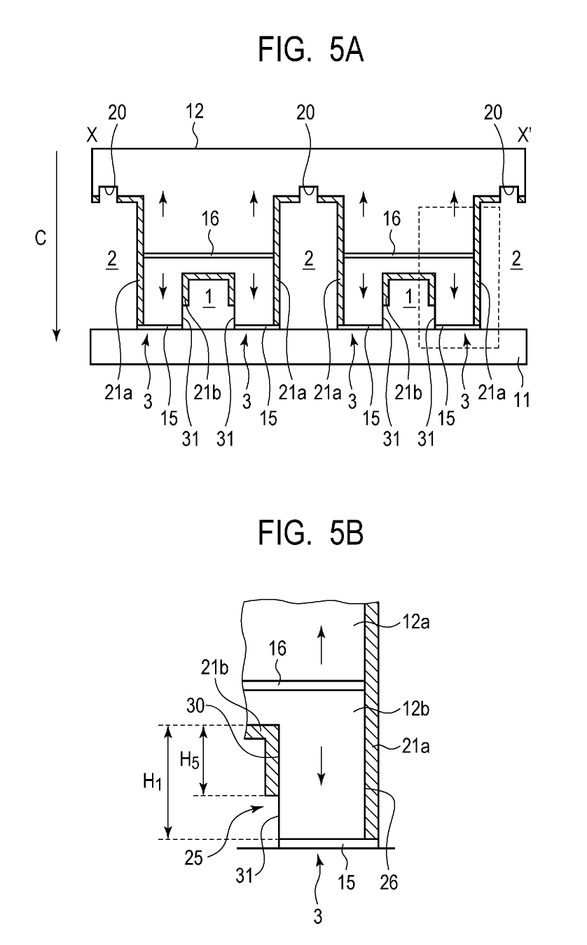

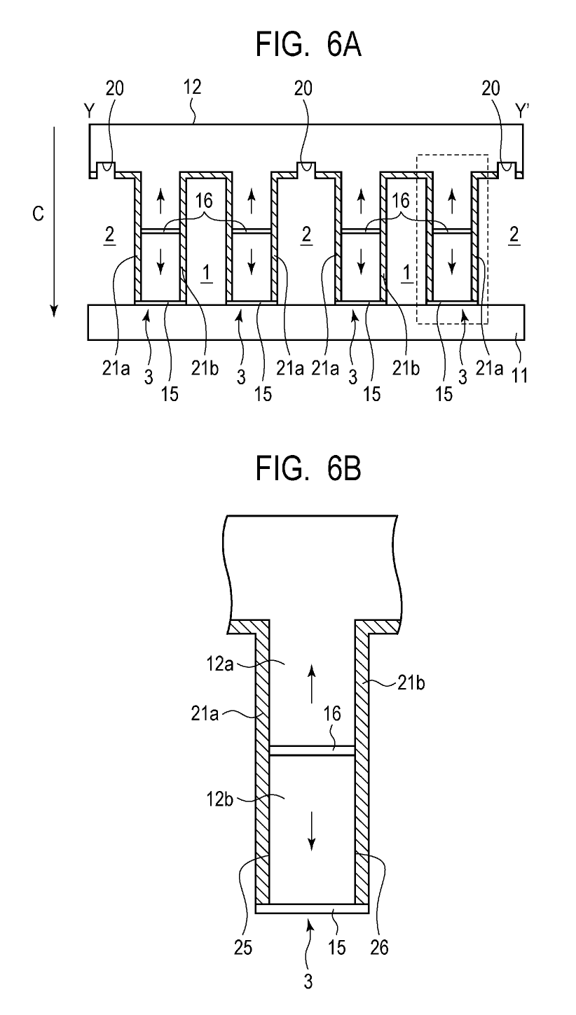

A liquid ejection device according to an embodiment of the present invention is described with reference to the drawings. FIG. 1 is an exploded perspective view for schematically illustrating the liquid ejection device according to this embodiment. FIG. 2 is a sectional view for illustrating a part of a piezoelectric transducer of the liquid ejection device according to this embodiment. FIG. 3 is a perspective view for illustrating a part of the piezoelectric transducer of the liquid ejection device according to this embodiment. FIG. 4 is a perspective view for illustrating a part of the piezoelectric transducer of the liquid ejection device according to this embodiment. FIG. 5A and FIG. 5B are sectional views for illustrating parts of the piezoelectric transducer of the liquid ejection device according to this embodiment. FIG. 5A corresponds to an X-X′ cross section of FIG. 3. FIG. 5B is an enlarged view of a part surrounded by the broken line of FIG. 5A. FIG. 6A is a sectional view for illustrating a part of the piezoelectric transducer of the liquid ejection device according to this embodiment. FIG. 6A corresponds to a Y-Y′ cross section of FIG. 3. FIG. 6B is an enlarged view of a part surrounded by the broken line of FIG. 6A.

Note that, a case where a piezoelectric plate 12 is positioned on an upper side and a cover plate 11 is positioned on a lower side is illustrated in FIG. 1, FIG. 3, and FIG. 5A to FIG. 6B, but a vertical relationship between the piezoelectric plate 12 and the cover plate 11 is not limited thereto. The piezoelectric plate 12 may be positioned on the lower side and the cover plate 11 may be positioned on the upper side. In this specification, description is made on the assumption that a surface of the piezoelectric plate 12 on the upper side of the drawing sheets of FIG. 1, FIG. 3, and FIG. 5A to FIG. 6B is a lower surface of the piezoelectric plate 12 and that a surface on the lower side of the drawing sheets of FIG. 1, FIG. 3, and FIG. 5A to FIG. 6B is an upper surface of the piezoelectric plate 12. A direction of the arrow C of FIG. 1, FIG. 3, and FIG. 5A to FIG. 6B is matched with a direction from the lower surface side toward the upper surface side of the piezoelectric plate 12. FIG. 4 is matched with the description of the vertical relationship in this specification.

As illustrated in FIG. 1, a liquid ejection device (inkjet head) 100 according to this embodiment includes a piezoelectric transducer (ejection unit or actuator) 10. The piezoelectric transducer 10 includes the piezoelectric plate (base or substrate main body) 12 and the cover plate (top) 11 mounted to one principal surface (surface on the lower side of FIG. 1) side of the piezoelectric plate 12. In addition, the liquid ejection device 100 according to this embodiment includes an orifice plate (nozzle plate) 60 mounted to a front surface side of the piezoelectric transducer 10 and a manifold 40 arranged on a back surface side of the piezoelectric transducer 10. In addition, the liquid ejection device 100 according to this embodiment includes a flexible substrate 50 for supplying power, which is mounted to one principal surface (surface on the upper side of the drawing sheet of FIG. 1) of the piezoelectric transducer 10.

The piezoelectric plate 12 has a substantially flat plate shape. The piezoelectric plate 12 includes a piezoelectric member 12a and a piezoelectric member 12b fixed on the piezoelectric member 12a. More specifically, as illustrated in FIG. 3, the piezoelectric plate 12 is formed by bonding two piezoelectric bodies (piezoelectric boards or piezoelectric materials) 12a and 12b having opposite polarization directions to each other by use of an adhesive layer 16. Polarization treatment is applied to the piezoelectric member (base-end-side piezoelectric material) 12a in a direction opposite to the direction indicated by the arrow C of FIG. 3. Polarization treatment is applied to the piezoelectric member (distal-end-side piezoelectric material) 12b in the direction indicated by the arrow C of FIG. 3. The piezoelectric plate 12 has a thickness of, for example, about 1 mm.

As a material of the piezoelectric bodies 12a and 12b, for example, piezoelectric ceramics is used. As the piezoelectric ceramics, for example, a lead zirconate titanate (PZT: PbZrₓTi₁₋ₓO₃)-based ceramics material, which is a ferroelectric ceramics material, is used. Note that, as the piezoelectric ceramics for forming the piezoelectric bodies 12a and 12b, there may be used, for example, barium titanate (BaTiO₃), or lanthanum-substituted lead zirconate titanate (PLZT: (Pb,La)(Zr,Ti)O₃).

A plurality of grooves (openings) 1 and 2 are formed in the piezoelectric plate 12 so as to be in parallel with one another. A longitudinal direction of the grooves 1 and 2 is matched with a direction indicated by the arrow A of FIG. 1. The groove 1 and the groove 2 are arranged alternately along a direction indicated by the arrow B of FIG. 1. Note that, the direction indicated by the arrow A of FIG. 1 is orthogonal to the direction indicated by the arrow B of FIG. 1. The groove 1 serves to form a pressure chamber (liquid channel). The groove 2 serves to form a dummy pressure chamber, that is, a dummy chamber. The grooves 1 and 2 extend from the front surface side (side to which the orifice plate 60 is mounted) of the piezoelectric transducer 10 to the back surface side (side to which the manifold 40 is mounted) of the piezoelectric transducer 10.

The piezoelectric plate 12 includes partitions (piezoelectric partitions) 3 defined between the groove 1 and the groove 2. Each of the partitions 3 separates pressure chambers 1 and 2 formed in groove shapes from each other. The longitudinal direction of the partition 3 is matched with the arrow A of FIG. 1. A plurality of partitions 3 are arranged at intervals along the direction indicated by the arrow B of FIG. 1. The partitions 3 extend from the front surface side of the piezoelectric transducer 10 to the back surface side of the piezoelectric transducer 10.

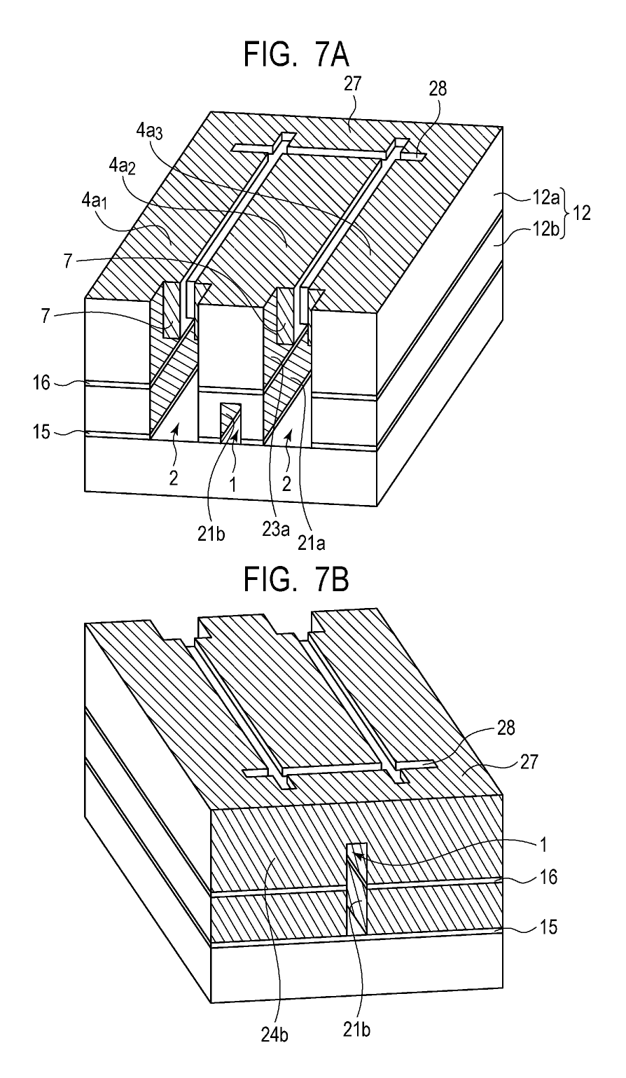

On an end surface of the front surface side of the piezoelectric plate 12, that is, an end surface of the piezoelectric plate 12 on the side to which the orifice plate 60 is mounted, a groove 7 for forming an extracting electrode 23a (see FIG. 7A) extracted from an electrode 21a formed in the groove 2 is formed. The longitudinal direction of the groove 7 is a direction of a normal to the principal surface of the piezoelectric plate 12. The groove 7 is connected to the groove 2 that forms the dummy chamber 2. An end surface of the partition 3 on the front surface side of the piezoelectric plate 12 protrudes relative to a bottom surface 14 (see FIG. 3) of the groove 7.

The cover plate (sometimes referred to simply as “plate”) 11 is mounted to an end surface (here referred to as “principal surface” (surface on the lower side of the drawing sheet of FIG. 1)) of the piezoelectric plate 12 along such a direction as to intersect with the end surface of the partition 3 on the front surface side. It is preferred to use, as the cover plate 11, for example, a material having a thermal expansion coefficient equivalent to that of the piezoelectric plate 12. Here, as a material of the cover plate 11, the same material as that of the piezoelectric plate 12 is used. One principal surface (end surface along such a direction as to intersect with the end surface of the partition 3 on the front surface side) (surface on the lower side of the drawing sheet of FIG. 1) of the piezoelectric plate 12 and one principal surface (surface on the upper side of the drawing sheet of FIG. 1) of the cover plate 11 are bonded together with, for example, an epoxy-based adhesive layer 15. The grooves 1 and 2 are covered with the cover plate 11, and hence pressure chambers are defined as parts in which the grooves 1 and 2 are formed. Note that, the pressure chamber 1 is defined as the part in which the groove 1 is formed, and hence the groove 1 and the pressure chamber 1 share the same reference numeral “1” in descriptions thereof. Further, the pressure chamber (dummy chamber) 2 is defined as the part in which the groove 2 is formed, and hence the groove 2 and the pressure chamber (dummy chamber) 2 share the same reference numeral “2” in descriptions thereof.

The pressure chamber 1 and the pressure chamber 2 adjacent to the pressure chamber 1 are separated from each other by the same partition 3. Therefore, it is not necessarily easy to independently control a capacity of the pressure chamber 1 and a capacity of the pressure chamber 2 adjacent to the pressure chamber 1. Therefore, the pressure chamber 1 is used as a liquid channel, and the pressure chamber 2 adjacent to the pressure chamber 1 is used as a dummy.

The respective capacities of the pressure chambers 1 and 2 can also be controlled so that the pressure chamber 2 can also be used as the liquid channel. For example, an electrode 21b (see FIG. 5A to FIG. 6B) formed to the partition 3 on one side of the pressure chamber 1 and the electrode 21b formed to the partition 3 on the other side of the pressure chamber 1 may be separated from each other, and different signal voltages may be applied to those electrodes 21b. Thus, it is possible to use not only the pressure chamber 1 but also the pressure chamber 2 as the liquid channel.

Here, a case where the pressure chamber 2 is not used as the liquid channel is described as an example.

As illustrated in FIG. 4, in a region 18 on the front surface side of the piezoelectric transducer 10, the pressure chamber 1 is set to be relatively small in depth (the pressure chamber 1 is set to be small in capacity). Specifically, in the region 18 positioned on one side of the pressure chamber 1 in a longitudinal direction A, a bottom of the pressure chamber 1 is positioned in a position shallower than a boundary between the piezoelectric member 12a and the piezoelectric member 12b. Therefore, in the region 18 on the front surface side of the piezoelectric transducer 10, the partition 3 is formed of only the piezoelectric member 12b serving as a first piezoelectric member. In this embodiment, a portion of a partition formed of only the piezoelectric member 12b serving as the first piezoelectric member is referred to as “first partition portion”. Note that, in this specification, for the sake of convenience of description, the same reference numeral “18” is used for the region on the front surface side of the piezoelectric transducer 10 and a region of the front surface side of the piezoelectric plate 12.

On the other hand, in a region 19 on the back surface side of the piezoelectric transducer 10, the pressure chamber 1 is set to be relatively large (wide) in depth. Specifically, in the region 19 positioned on the other side of the pressure chamber 1 in the longitudinal direction A, the bottom of the pressure chamber 1 is positioned in a position deeper than the boundary between the piezoelectric member 12a and the piezoelectric member 12b. Therefore, in the region 19 on the back surface side of the piezoelectric plate 12, the partition 3 is formed of the piezoelectric member 12a and the piezoelectric member 12b. Specifically, in the region 19 on the back surface side of the piezoelectric plate 12, the partition 3 has a chevron structure. In this embodiment, a portion of a partition formed of the piezoelectric member 12b serving as the first piezoelectric member and the piezoelectric member 12a serving as a second piezoelectric member is referred to as “second partition portion”. Note that, in this specification, for the sake of convenience of description, the same reference numeral “19” is used for the region on the back surface side of the piezoelectric transducer 10 and a region of the back surface side of the piezoelectric plate 12.

As illustrated in FIG. 5A to FIG. 6B, each of the partitions 3 includes a side wall (sometimes referred to also as “side surface”) 25 and a side wall (sometimes referred to also as “side surface”) 26 positioned on a back surface side of the side wall 25. The side wall 25 faces the pressure chamber 1, and the side wall 26 faces the dummy chamber 2. The side wall 25 of one partition 3 and the side wall 25 of another partition 3 adjacent to the one partition 3 are opposed to each other. Further, the side wall 26 of one partition 3 and the side wall 26 of another partition 3 adjacent to the one partition 3 are opposed to each other.

The electrodes (drive electrodes) 21b are formed in the pressure chamber 1. The electrode 21b formed in the pressure chamber 1 is used for applying, in combination with the electrode 21a formed in the dummy chamber 2 to be described later, the partition (piezoelectric member) 3 with an electric field in a direction perpendicular to the polarization direction to displace the partition 3 in a shear mode. The electrodes 21b are formed on the side walls 25 of the partition 3 and a bottom surface of the groove 1.

The electrode 21b is not formed on a wall surface (side surface) 31 positioned in an upper portion (predetermined range from an end surface (surface to be bonded to the cover plate) of the first partition portion) of the partition 3 in the region 18 on the front surface side of the piezoelectric transducer 10, but is formed on a wall surface 30 positioned below the wall surface 31 (range other than the predetermined range) (FIG. 5B). In other words, an electrode formed on at least one side surface of the first partition portion is formed within a range other than the predetermined range from the end surface (surface to be bonded to the cover plate) of the first partition portion. Here, for the sake of convenience of description, the description is made on the assumption that the upper side of the drawing sheets of FIG. 5A and FIG. 5B is the lower side and that the lower side of the drawing sheets of FIG. 5A and FIG. 5B is the upper side. Further, the description is made on the assumption that the predetermined range in which the electrode 21b is not formed is on the side surface of the first partition portion on a pressure chamber side, but the present invention is not limited thereto, and the predetermined range may be on any one side surface of the first partition portion or both side surfaces of the first partition portion. In other words, the electrode 21a on a dummy chamber side may not be formed in the predetermined range. In the region 18 on the front surface side of the piezoelectric transducer 10, a height (height from the bottom surface of the groove 1 to an upper end of the electrode 21b) H₅ of the electrode 21b within the pressure chamber 1 is set to, for example, about half as much as a height (height from the bottom surface of the groove 1 to the upper surface of the partition 3) H₁ of the partition 3. In other words, the height H₅ of the electrode 21b is set to about half as much as the height H₁ of the partition 3 in the region 18 positioned on one side of the pressure chamber 1 in the longitudinal direction A. In other words, it is preferred that an area of the predetermined range of the first partition portion, in which the electrode 21b or the electrode 21a is not formed be 35% or more and 75% or less of an area of a surface of the first partition portion that faces the pressure chamber. Note that, the height H₅ of the electrode 21b within the pressure chamber 1 is not limited thereto, and can be set appropriately so as to allow the partition 3 to be sufficiently displaced. The electrode 21b within the pressure chamber 1 is connected to, for example, a ground potential GND. In this way, in this embodiment, the upper end of the electrode 21b is positioned below the upper surface of the partition 3. Specifically, in this embodiment, the upper end of the electrode 21b is recessed in a direction from a top portion of the partition 3 toward bottoms of the grooves 1 and 2.

On the other hand, in the region 19 on the back surface side of the piezoelectric transducer 10, as illustrated in FIGS. 6A and 6B, the height of the electrode 21b formed in the pressure chamber 1 is the same as the height of the partition 3. Specifically, in the region 19 positioned on the other side of the pressure chamber 1 in the longitudinal direction A, the upper end of the electrode 21b formed in the pressure chamber 1 is matched in level with an upper end of the partition 3.

The electrode 21a is formed on the side walls 26 of the partition 3 and a bottom surface of the groove 2. The height (height from the bottom surface of the groove 1 to the upper end of the electrode 21a) of the electrode 21a is set, for example, to be the same as the height (height from the bottom surface of the groove 1 to the upper surface of the partition 3) H₁ of the partition 3. Note that, the height of the electrode 21a is not limited thereto, and can be set appropriately so as to allow the partition 3 to be sufficiently displaced. The electrode 21a positioned on one side of the dummy chamber 2 and the electrode 21a positioned on the other side of the dummy chamber 2 are separated from each other by a separating groove 20 formed on a bottom surface of the dummy chamber 2. The separating groove 20 is formed along the longitudinal direction (direction indicated by the arrow A) of the dummy chamber 2 so as to extend from one end of the groove 2 and reach the other end of the groove 2. Further, in the groove 7 formed on the front surface side of the piezoelectric plate 12, the separating groove 20 is connected to a separating groove 28 formed on one principal surface (surface on the upper side of the drawing sheet of FIG. 1) of the piezoelectric plate 12 (see FIG. 1). For example, a signal voltage (control voltage or control signal) for applying an electric field having a desired magnitude to the partition 3 is applied to the electrode 21a. The electrode 21a positioned on one side of the dummy chamber 2 and the electrode 21a positioned on the other side of the dummy chamber 2 are electrically separated from each other, and hence it is possible to apply different signal voltages to those electrodes 21a.

The pressure chamber 1 is formed so as to reach the end surface of the piezoelectric plate 12 on the back surface side, that is, the end surface of the piezoelectric plate 12 on the side to which the manifold 40 is mounted (see FIG. 7A and FIG. 7B). With this, liquid is supplied from the manifold 40 into the dummy chamber 2.

On the other hand, the dummy chamber 2 is formed so as not to reach the end surface of the piezoelectric plate 12 on the back surface side, that is, the end surface of the piezoelectric plate 12 on the side to which the manifold 40 is mounted. With this, the liquid is prevented from being supplied from the manifold 40 into the dummy chamber 2.

The manifold 40 is mounted to the back surface side of the piezoelectric transducer 10. A common liquid chamber 43 (see FIG. 2) for supplying liquid (ink) to the pressure chamber 1 of the piezoelectric transducer 10 is formed in the manifold 40. The manifold 40 is constructed such that liquid reserved in a liquid bottle (not shown) is supplied into the manifold 40 through an ink supply port 41 formed on a back surface side of the manifold 40. Further, an ink discharge port (ink collecting port) 42 is also formed on the back surface side of the manifold 40. The ink supply port 41 and the ink discharge port 42 are formed in the manifold 40, which allows the ink to be circulated in the manifold 40.

The orifice plate 60 is mounted on the front surface (surface on a liquid ejecting side) side of the piezoelectric transducer 10. The orifice plate 60 is formed of, for example, plastic. Nozzles (discharge ports) 60a are formed in the orifice plate 60 at positions corresponding to those of the pressure chambers (liquid channels) 1. The nozzles 60a are arrayed in the direction indicated by the arrow B of FIG. 1. The orifice plate 60 is bonded to the end surface of the piezoelectric transducer 10 on the front surface side with, for example, an epoxy-based adhesive (not shown).

As illustrated in FIG. 2, liquid (ink) I supplied from an ink tank (not shown) is supplied to each of the pressure chambers 1 through the ink supply port 41 and the common liquid chamber 43, to be appropriately ejected through each of the nozzles 60a.

As illustrated in FIG. 3, a plurality of extracting electrodes 4 are formed on one principal surface (surface on the upper side of the drawing sheet of FIG. 3) 56 of the piezoelectric plate 12. Those extracting electrodes 4 are formed so as to correspond to the respective pressure chambers 1. The extracting electrode 4 is electrically connected to the electrode 21a or the like through extracting wiring (not shown). As illustrated in FIG. 1, the flexible substrate 50 is mounted on one surface (surface on the upper side of the drawing sheet of FIG. 1) of the piezoelectric plate 12. A plurality of signal lines (signal wiring or signal electrodes) 51 are formed on the flexible substrate 50. The signal line 51 of the flexible substrate 50 illustrated in FIG. 1 and the extracting electrode 4 illustrated in FIG. 3 are aligned to be connected to each other.

Next, a method of applying a voltage to the each electrode of the liquid ejection device according to this embodiment is described with reference to FIG. 7A and FIG. 7B. FIG. 7A and FIG. 7B are perspective views for illustrating a part of the piezoelectric transducer of the liquid ejection device according to this embodiment. For brevity of description, the illustrations of FIG. 7A and FIG. 7B include only one pressure chamber 1. FIG. 7A is a perspective view of the piezoelectric transducer 10 when viewed from the front surface side, and FIG. 7B is a perspective view of the piezoelectric transducer 10 when viewed from the back surface side.

As illustrated in FIG. 7A, a plurality of extracting electrodes 4a₁, 4a₂, and 4a₃ and a common electrode 27 are formed on one principal surface (surface on the upper side of the drawing sheet of FIG. 7A) of the piezoelectric plate 12.

As illustrated in FIG. 7A, the extracting electrode 23a is formed in the groove 7 formed on the front surface side of the piezoelectric plate 12. The extracting pattern (extracting electrode) 23a formed in the groove 7 is connected to the electrode 21a formed in the dummy chamber 2. Further, the extracting pattern 23a formed in the groove 7 is connected to the extracting electrode 4a₂ formed on one principal surface (surface on the upper side of the drawing sheet of FIG. 7A) of the piezoelectric plate 12. Thus, the extracting electrode 4a₂ formed on one principal surface of the piezoelectric plate 12 and the electrode 21a formed in the dummy chamber 2 are electrically connected to each other through the extracting pattern 23a.

As illustrated in FIG. 7B, an extracting pattern (extracting electrode or back electrode) 24b is formed on the back surface side of the piezoelectric plate 12. The extracting pattern 24b formed on the back surface side of the piezoelectric plate 12 is connected to the electrode 21b formed in the pressure chamber 1. Further, the extracting pattern 24b formed on the back surface side of the piezoelectric plate 12 is connected to the common electrode 27 formed on one principal surface (surface on the upper side of the drawing sheet of FIG. 7B) of the piezoelectric plate 12. The extracting electrodes 4a₁ and 4a₃ are connected to the common electrode 27. Accordingly, the extracting electrodes 4a₁ and 4a₃ formed on one principal surface of the piezoelectric plate 12 are electrically connected to the electrode 21b formed in the pressure chamber 1 through the common electrode 27 and the extracting pattern 24b.

The extracting electrodes 4a₁, 4a₂, and 4a₃ are electrically connected to the respective signal lines 51 formed on the flexible substrate 50 (FIG. 1). Therefore, the respective signal lines 51 formed on the flexible substrate 50 are electrically connected to the electrode 21a formed in the dummy chamber 2 and the electrode 21b formed in the pressure chamber 1.

Therefore, when a voltage Va is applied to any one of the signal lines 51 formed on the flexible substrate 50 (FIG. 1), the voltage Va is applied to the electrode 21a within the dummy chamber 2 through the extracting electrode 4a₂ and the extracting pattern 23a.

Further, in the same manner, when a voltage Vb is applied to any one of the signal lines 51 formed on the flexible substrate 50 (FIG. 1), the voltage Vb is applied to the electrode 21b within the pressure chamber 1 through the extracting electrodes 4a₁ and 4a₃ and the extracting pattern 24b.

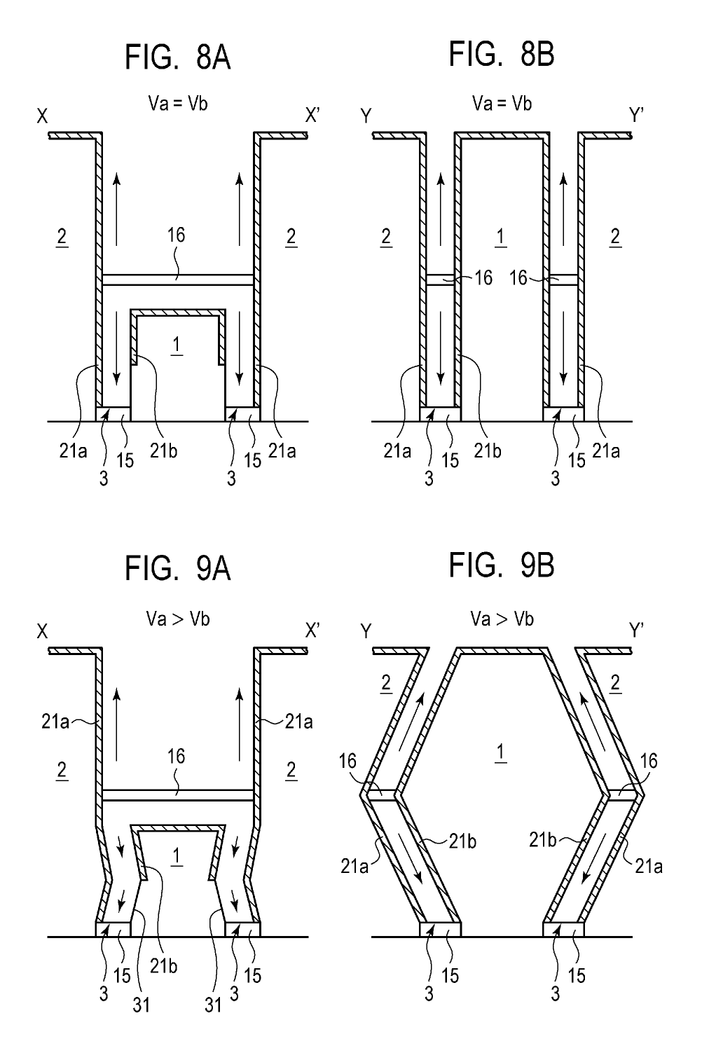

Next, displacement of the partition of the piezoelectric transducer of the liquid ejection device according to this embodiment is described with reference to FIG. 8A to FIG. 10B.

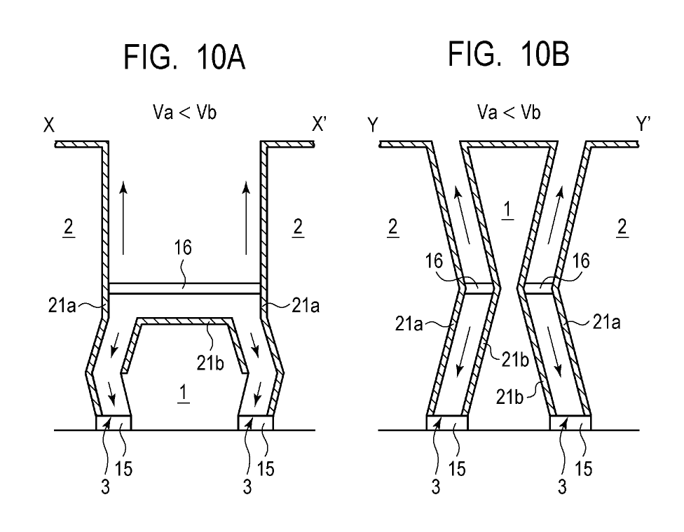

FIG. 8A to FIG. 10B are sectional views for illustrating the displacement of the partition of the piezoelectric transducer of the liquid ejection device according to this embodiment. Note that, the description is made here on the assumption that the electrode 21a within the dummy chamber 2 has a potential Va and that the electrode 21b within the pressure chamber 1 has a potential Vb. FIG. 8A, FIG. 9A, and FIG. 10A each correspond to an X-X′ cross section of FIG. 3. Specifically, FIG. 8A, FIG. 9A, and FIG. 10A are views for each illustrating a cross section of the region 18 on the front surface side of the piezoelectric transducer 10. FIG. 8B, FIG. 9B, and FIG. 10B each correspond to a Y-Y′ cross section of FIG. 3. Specifically, FIG. 8B, FIG. 9B, and FIG. 10B are views for each illustrating a cross section of the region 19 on the back surface side of the piezoelectric transducer 10.

A case where the potential Va of the electrode 21a within the dummy chamber 2 is equal to the potential Vb of the electrode 21b within the pressure chamber 1, that is, a case where Va=Vb, is illustrated in FIG. 8A and FIG. 8B. As can be seen from FIG. 8A, in the region 18 on the front surface side of the piezoelectric transducer 10, the partition 3 is not deformed. Further, as can be seen from FIG. 8B, in the region 19 on the back surface side of the piezoelectric plate 12, the partition 3 is not deformed as well.

A case where the potential Va of the electrode 21a within the dummy chamber 2 is higher than the potential Vb of the electrode 21b within the pressure chamber 1, that is, a case where Va>Vb, is illustrated in FIG. 9A and FIG. 9B. The potential Va of the electrode 21a within the dummy chamber 2 is higher than the potential of the electrode 21b within the pressure chamber 1, and hence an electric field is applied in a direction orthogonal to the polarization direction.

As illustrated in FIG. 9A, in the region 18 on the front surface side of the piezoelectric transducer 10, the partition 3 is displaced so that a cross sectional area of the pressure chamber 1 decreases.

As illustrated in FIG. 9B, in the region 19 on the back surface side of the piezoelectric transducer 10, the partition 3 is displaced so that the cross sectional area of the pressure chamber 1 increases.

A case where the potential Va of the electrode 21a within the dummy chamber 2 is lower than the potential Vb of the electrode 21b within the pressure chamber 1, that is, a case where Va<Vb, is illustrated in FIG. 10A and FIG. 10B. The potential Va of the electrode 21a within the dummy chamber 2 is lower than the potential of the electrode 21b within the pressure chamber 1, and hence, an electric field is applied in a direction opposite to the direction of the electric field in the case of FIG. 9A and FIG. 9B.

As illustrated in FIG. 10A, in the region 18 on the front surface side of the piezoelectric transducer 10, the partition 3 is displaced so that the cross sectional area of the pressure chamber 1 increases.

As illustrated in FIG. 10B, in the region 19 on the back surface side of the piezoelectric transducer 10, the partition 3 is displaced so that the cross sectional area of the pressure chamber 1 decreases.

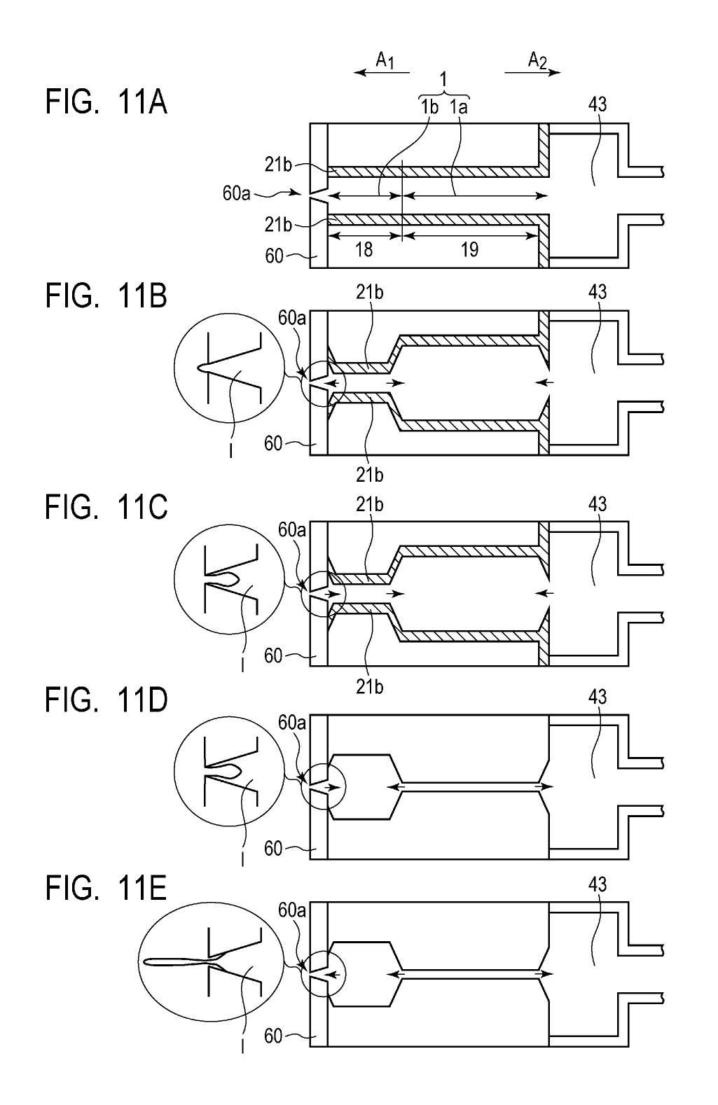

Next, an operation of the liquid ejection device according to this embodiment is described with reference to FIG. 11A to FIG. 11E.

FIG. 11A to FIG. 11E are sectional views for illustrating the operation of the piezoelectric transducer of the liquid ejection device according to this embodiment. Here, a part of the pressure chamber 1 that is positioned in the region 18 on the front surface side of the piezoelectric transducer 10 is a partial pressure chamber 1b. Further, a part of the pressure chamber 1 that is positioned in the region 19 on the back surface side of the piezoelectric transducer 10 is a partial pressure chamber 1a.

A case where the potential Va of the electrode 21a within the dummy chamber 2 is equal to the potential Vb of the electrode 21b within the pressure chamber 1, that is, a case where Va=Vb, is illustrated in FIG. 11A. Specifically, a state illustrated in FIG. 11A corresponds to the state described above with reference to FIG. 8A and FIG. 8B. In the state illustrated in FIG. 11A, the ink I within the pressure chamber 1 does not flow.

FIG. 11B is an illustration of a state immediately after the voltage is applied so that the potential Va of the electrode 21a within the dummy chamber 2 becomes higher than the potential Vb of the electrode 21b within the pressure chamber 1, that is, a state immediately after the voltage is applied so as to satisfy Va>Vb. The state illustrated in FIG. 11B corresponds to the state described above with reference to FIG. 9A and FIG. 9B. In the region 18 on the front surface side of the piezoelectric transducer 10, the partition 3 is displaced in such a direction as to contract the pressure chamber 1 (FIG. 9A). Specifically, the partition 3 is displaced in such a direction as to contract the partial pressure chamber 1b. On the other hand, in the region 19 on the back surface side of the piezoelectric transducer 10, the partition 3 is displaced in such a direction as to expand the pressure chamber 1 (FIG. 9B). Specifically, the partition 3 is displaced in such a direction as to expand the partial pressure chamber 1a.

When the partition 3 is thus displaced, the ink I flows into the partial pressure chamber 1a positioned in the region 19 on the back surface side of the piezoelectric transducer 10. On the other hand, in the partial pressure chamber 1b positioned in the region 18 on the front surface side of the piezoelectric transducer 10, the ink I in the vicinity of the nozzle 60a flows in an ejection direction A₁.

FIG. 11C is an illustration of a state after a fixed time has elapsed since the voltage is applied so as to satisfy Va>Vb. In this case, in the partial pressure chamber 1b positioned in the region 18 on the front surface side of the piezoelectric transducer 10, the direction in which the ink I in the vicinity of the nozzle 60a flows is reversed. Specifically, in FIG. 11B, the ink I in the vicinity of the nozzle 60a flows in the ejection direction A₁, while in FIG. 11C, the ink I in the vicinity of the nozzle 60a flows toward a direction A₂ opposite to the ejection direction A₁. It is also conceivable that the flow of the ink I in the vicinity of the nozzle 60a is reversed in this way for the following reason. Specifically, a displacement amount of the partition 3 in the region 19 on the back surface side of the piezoelectric transducer 10 is larger than a displacement amount of the partition 3 in the region 18 on the front surface side of the piezoelectric transducer 10. Therefore, a change amount in the capacity of the partial pressure chamber 1a positioned in the region 19 on the back surface side of the piezoelectric transducer 10 becomes larger than a change amount in the capacity of the partial pressure chamber 1b positioned in the region 18 on the front surface side of the piezoelectric transducer 10. It is conceivable that the flow of the ink I drawn into the partial pressure chamber 1b becomes therefore dominant, and hence the flow of the ink I in the vicinity of the nozzle 60a is reversed.

FIG. 11D is an illustration of a state immediately after the voltage is applied so that the potential Va of the electrode 21a within the dummy chamber 2 becomes lower than the potential Vb of the electrode 21b within the pressure chamber 1, that is, a state immediately after the voltage is applied so as to satisfy Va<Vb. The state illustrated in FIG. 11D corresponds to the state described above with reference to FIG. 10A and FIG. 10B. In the region 18 on the front surface side of the piezoelectric transducer 10, the partition 3 is displaced in such a direction as to expand the pressure chamber 1 (FIG. 10A). Specifically, the partition 3 is displaced in such a direction as to expand the partial pressure chamber 1b. On the other hand, in the region 19 on the back surface side of the piezoelectric transducer 10, the partition 3 is displaced in such a direction as to contract the pressure chamber 1 (FIG. 10B). Specifically, the partition 3 is displaced in such a direction as to contract the partial pressure chamber 1a. When the partition 3 is thus displaced, the ink I flows out of the partial pressure chamber 1a positioned in the region 19 on the back surface side of the piezoelectric transducer 10. On the other hand, in the partial pressure chamber 1b positioned in the region 18 on the front surface side of the piezoelectric transducer 10, the ink I in the vicinity of the nozzle 60a flows in the direction A₂ opposite to the ejection direction A₁.

FIG. 11E is an illustration of a state after a fixed time has elapsed since the voltage is applied so as to satisfy Va<Vb. In this case, in the partial pressure chamber 1b positioned in the region 18 on the front surface side of the piezoelectric transducer 10, the flow of the ink I in the vicinity of the nozzle 60a is reversed. Specifically, in FIG. 11D, the ink I in the vicinity of the nozzle 60a flows in the direction A₂ opposite to the ejection direction A₁, while in FIG. 11E, the ink I in the vicinity of the nozzle 60a flows toward the ejection direction A₁.

In this embodiment, in the case of FIG. 11D, the ink I in the vicinity of the nozzle 60a flows in the direction A₂ opposite to the ejection direction A₁. The flow of the ink I in the opposite direction A₂ plays a role in alleviating the flow of the ink I flowing in the ejection direction A₁ in the case of FIG. 11E. Therefore, according to this embodiment, sudden concentration of ink into the nozzle 60a can be alleviated, and a liquid droplet (satellite droplet) separate from a main droplet (main liquid droplet) of the ink can be inhibited from being formed before the main droplet. Therefore, according to this embodiment, it is possible to provide a liquid ejection device capable of ejecting liquid with stability.

Further, it is possible to eject liquid with stability at a desired ejection speed by appropriately setting the displacement amount of the partition 3 in the region 18 on the front surface side of the piezoelectric transducer 10 and the displacement amount of the partition 3 in the region 19 on the back surface side of the piezoelectric transducer 10.

In this way, according to this embodiment, in the region 19 on the back surface side of the piezoelectric transducer 10, the bottom surface of the pressure chamber 1 is positioned in the position deeper than the boundary between the piezoelectric member 12a and the piezoelectric member 12b. On the other hand, in the region 18 on the front surface side of the piezoelectric transducer 10, the bottom surface of the pressure chamber 1 is positioned in the position shallower than the boundary between the piezoelectric member 12a and the piezoelectric member 12b. Further, on the front surface side of the piezoelectric transducer 10, the upper end of the first electrode 21b is positioned below the upper surface of the partition 3. Therefore, according to this embodiment, the partition 3 can be displaced in the region 18 on the front surface side of the piezoelectric transducer 10. Accordingly, when the pressure chamber 1 is contracted in the region 19 on the back surface side of the piezoelectric transducer 10, the pressure chamber 1 is expanded in the region 18 on the front surface side of the piezoelectric transducer 10. Therefore, according to this embodiment, when the liquid droplet is ejected by contracting the region 19 on the back surface side of the piezoelectric transducer 10, it is possible to alleviate the sudden concentration of pressure into a nozzle, which can inhibit a satellite droplet from being generated. Accordingly, according to this embodiment, it is possible to provide a liquid ejection device capable of ejecting a minute liquid droplet with stability.

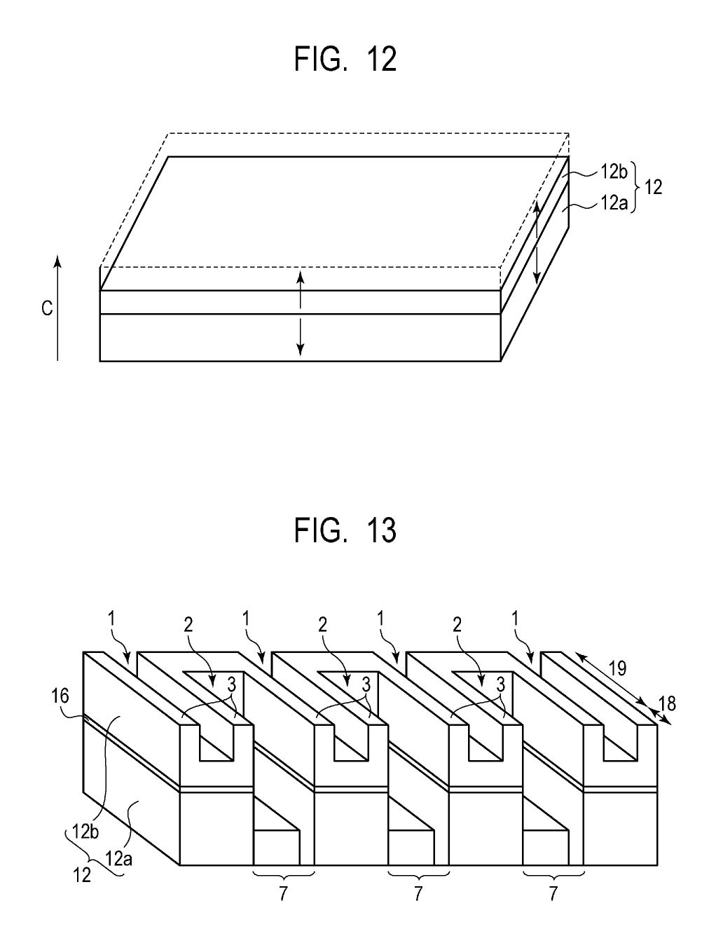

Next, a method of manufacturing a liquid ejection device according to this embodiment is described with reference to FIG. 12 to FIG. 17. FIG. 12 to FIG. 17 are process views for illustrating the method of manufacturing a liquid ejection device according to this embodiment.

First, two piezoelectric substrates (piezoelectric bodies) 12a and 12b having opposite polarization directions are bonded together by use of the adhesive layer 16 (see FIG. 3). The polarization treatment is applied to the piezoelectric member (base-end-side piezoelectric material) 12a in the direction opposite to the direction indicated by the arrow C of FIG. 12. The polarization treatment is applied to the piezoelectric member (distal-end-side piezoelectric material) 12b in the direction indicated by the arrow C of FIG. 12. As the material of the piezoelectric bodies 12a and 12b, for example, PZT, barium titanate, or PLZT is used. Here, for example, PZT is used as the material of the piezoelectric bodies 12a and 12b.

Subsequently, a surface of the piezoelectric member 12b is subjected to cutting (grinding) so that the thickness of the piezoelectric member 12b becomes a desired thickness. In this way, the piezoelectric plate 12 in which the piezoelectric member 12b having a desired thickness is arranged on the piezoelectric member 12a is obtained (see FIG. 12). Note that, the broken line of FIG. 12 is an illustration of a state before the piezoelectric member 12b is subjected to the grinding.

Subsequently, as illustrated in FIG. 13, the grooves 1 for forming the pressure chambers are formed in the piezoelectric plate 12 by use of, for example, a diamond blade (not shown). That is, the grooves are formed to form the pressure chambers separated by the partitions having the first partition portion obtained by cutting up to the first piezoelectric member and the second partition portion obtained by cutting from the first piezoelectric member up to the second piezoelectric member.

Specifically, the plurality of grooves 1 are formed so as to be in parallel with one another. In the forming of the grooves 1, only the piezoelectric member 12b is processed in the region 18 in the vicinity of the end surface of the piezoelectric plate 12 on the front surface side (front side of the drawing sheet of FIG. 13). On the other hand, both the piezoelectric member 12a and the piezoelectric member 12b are processed in the region 19 on the back surface side of the piezoelectric plate 12. In the region 18 in the vicinity of the end surface of the piezoelectric plate 12 on the front surface side, the processing is performed so that the grooves 1 become shallow. On the other hand, in the region 19 on the back surface side of the piezoelectric plate 12, the processing is performed so that the grooves 1 become deep. It is preferred to use, as a dicing apparatus, a dicing apparatus that can be at least biaxially controlled. In this case, as the dicing apparatus, for example, a dicing saw manufactured by DISCO Corporation (trade name: Fully Automatic Dicing Saw, model No: DAD6240, spindle type: 1.2 kW) is used. It is preferred not to set a feeding speed of a stage that supports the piezoelectric plate 12 to be excessively high, in order to prevent the piezoelectric plate 12 from being excessively stressed when being processed by use of the diamond blade. Note that, some of a large number of grooves 1 to be formed are extracted in the illustration of FIG. 13.

Then, the grooves 2 for forming the dummy chambers are formed in the piezoelectric plate 12 by use of the diamond blade (not shown). As a dicing apparatus, for example, a dicing apparatus similar to the dicing apparatus used in forming the grooves 1 can be used. The grooves 2 are formed so as to be along the longitudinal direction of the grooves 1. The plurality of grooves 2 are formed so as to be in parallel with one another. Regions in which the grooves 2 are to be formed are set so that the plurality of grooves 2 are at the centers between the plurality of grooves 1 formed so as to be in parallel with one another, respectively. The grooves 2 are formed so as not to reach the end surface of the piezoelectric plate 12 on the back surface side. This is for the purpose of preventing liquid from being supplied from the manifold 40 into the dummy chambers 2. In the region 19 on the back surface side of the piezoelectric plate 12, the depth of the grooves 2 is, for example, the same as that of the grooves 1. Note that, the depth of the grooves 2 is not required to be the same as that of the grooves 1. For example, the depth of the grooves 2 may be appropriately set in a range of from 1 to 1.15 times as much as the depth of the grooves 1. A portion between the groove 1 and the groove 2 serves as the partition 3. The partition 3 is positioned on both sides of the pressure chamber formed by the groove 1.

Then, the grooves 7 are formed in the end surface of the piezoelectric plate 12 on the front surface side by use of the diamond blade (not shown). The grooves 7 are formed so as to extend in the direction of the normal to the principal surface of the piezoelectric plate 12. The grooves 7 are formed for the purpose of forming the extracting electrodes 23a extracted from the electrodes 21a. Processing conditions in forming the grooves 7 are, for example, similar to processing conditions in forming the grooves 2. The grooves 7 are formed on the front surface side of the piezoelectric plate 12, that is, on the front side of the drawing sheet of FIG. 13, so as to communicate to the grooves 2.

Note that, the case of the processing using the diamond blade is described here as an example, but the present invention is not limited thereto.

A processing tool capable of performing the processing so as to keep the piezoelectric plate 12 below a Curie temperature can be appropriately used. For example, the piezoelectric plate 12 may be processed by use of an end mill or the like.

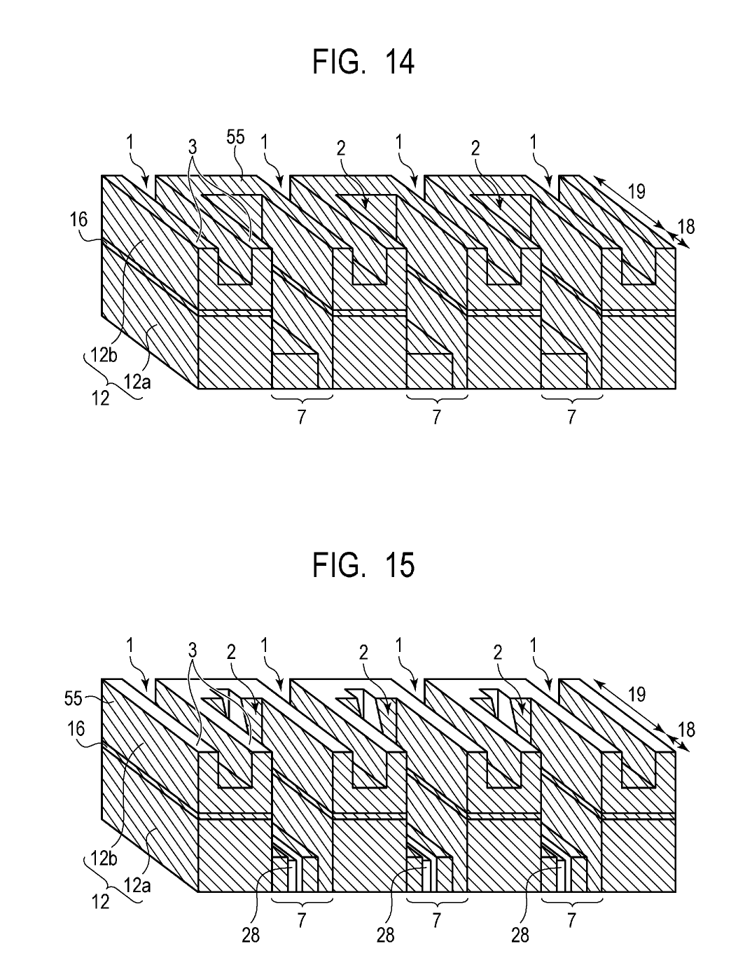

Then, as illustrated in FIG. 14, a conductive film 55 serving as an electrode covering an entire surface of the piezoelectric plate 12 is formed. The conductive film 55 can be formed as described below.

First, by etching the surface of the piezoelectric plate 12, minute depressions (unevenness) are formed in the surface of the piezoelectric plate 12. Then, de-leading treatment for removing from the surface of the piezoelectric plate 12 lead (Pb) contained in the material of the piezoelectric plate 12 is applied.

Next, as described below, a plated catalyst is deposited onto the surface of the piezoelectric plate 12. For example, tin (Sn) and palladium (Pd) are used as the plated catalyst. In this case, the deposition is described by way of the case where the plated catalyst of palladium is generated. First, the piezoelectric plate 12 is immersed into an aqueous solution of stannous chloride with a concentration of about 0.1%, thereby depositing stannous chloride onto the surface of the piezoelectric plate 12. Subsequently, the piezoelectric plate 12 is immersed into an aqueous solution of palladium chloride with a concentration of about 0.1%, thereby allowing an oxidation-reduction reaction between tin chloride, which is deposited onto the piezoelectric plate 12 in advance, and palladium chloride to occur to generate metallic palladium on the surface of the piezoelectric plate 12. Thus, the plated catalyst of metallic palladium is deposited onto the surface of the piezoelectric plate 12.

Next, the piezoelectric plate 12 in which metallic palladium is generated on its surface is immersed into, for example, a nickel plating bath, thereby forming an electroless plating film containing nickel (Ni) on the surface of the piezoelectric plate 12. For example, the following films are formed as the electroless plating film: an electroless plating film of nickel-phosphorus (Ni—P) and an electroless plating film of nickel-boron (Ni—B). It is preferred that a thickness of the electroless plating film be set to be about 0.5 μm to 1.0 μm for the purpose of sufficiently cover the surface of the piezoelectric plate 12 and sufficiently reducing electrical resistance. In this way, the electroless plating film is formed on the entire surface of the piezoelectric plate 12.

After that, for example, through replacement plating, a gold (Au) plating film, for example, is formed on the electroless plating film. In this way, the conductive film 55 including the plating film is formed on the entire surface of the piezoelectric plate 12.

Then, unnecessary portions of the conductive film 55 formed on the entire surface of the piezoelectric plate 12 are removed (see FIG. 15). The unnecessary portions of the conductive film 55 can be removed as described below.

Portions of the conductive film 55 on one principal surface (surface on the upper side of the drawing sheet of FIG. 15) and on the other principal surface (surface on the lower side of the drawing sheet of FIG. 15) of the piezoelectric plate 12 are removed. The portions of the conductive film 55 on one principal surface and on the other principal surface of the piezoelectric plate 12 can be removed by, for example, polishing.

Further, the separating groove 20 is formed at the bottom of the groove 2 to serve as the dummy chamber, and the separating groove 28 is formed at the bottom of the groove 7 for the extracting electrode. Those separating grooves 20 and 28 are for the purpose of separating the electrode 21a positioned on one side of the grooves 2 and 7 and the electrode 21a positioned on the other side of the grooves 2 and 7 from each other. When the separating grooves 20 and 28 are formed, for example, the diamond blade can be used. The separating grooves 20 and 28 each have a width of, for example, about ½ to ⅓ of the width of the groove 2 or 7. Note that, the width of the separating grooves 20 and 28 is not limited thereto, and may be appropriately set. The separating groove 20 is formed along the longitudinal direction of the groove 2 so as to extend from a front end of the groove 2 to reach a rear end thereof. Further, the separating groove 28 is formed along the longitudinal direction of the groove 7 so as to extend from an upper end of the groove 7 to reach a lower end thereof. The electrode 21a positioned on one side of the groove 2 or 7 and the electrode 21a positioned on the other side of the groove 2 or 7 are separated from each other, and thus, different signal voltages can be applied to those electrodes 21a. Therefore, the partitions 3 of the pressure chambers 1 can be individually displaced.

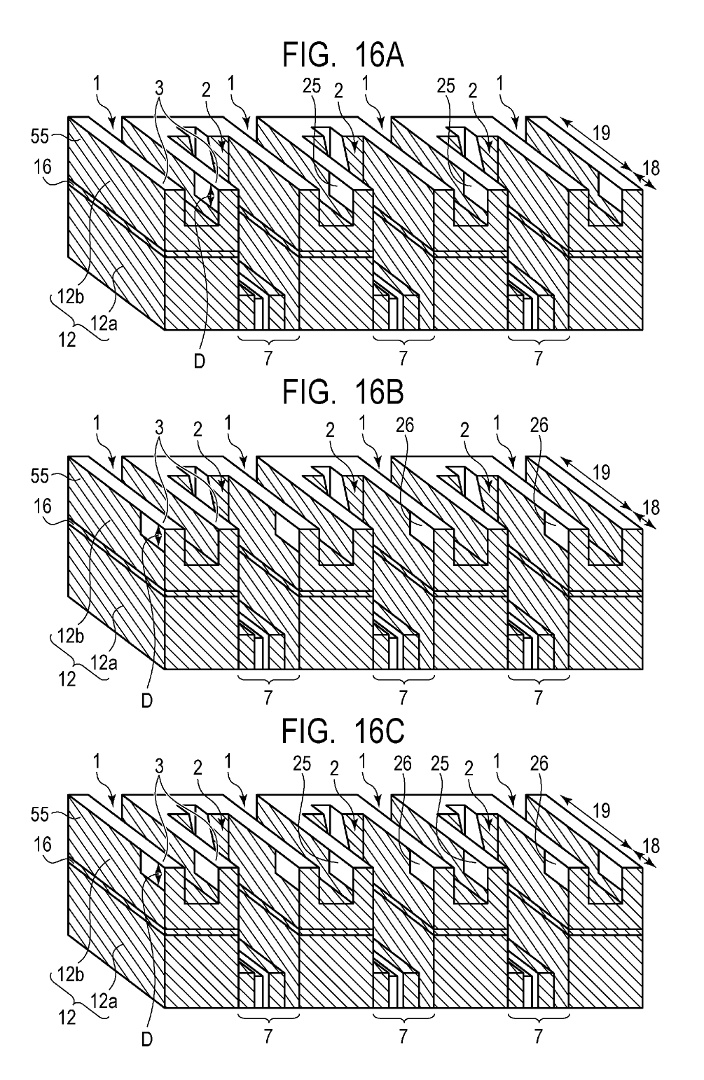

Subsequently, as illustrated in FIG. 16A, a part of the conductive film 55 existing in the region 18 on the front surface side of the piezoelectric plate 12 is removed. In other words, the electrode (conductive film 55) formed on at least one side surface of the first partition portion and formed within the predetermined range from the end surface (surface to be bonded to the cover plate) of the partition is removed. Specifically, the conductive film 55 in the upper portion of the side wall 25 of the partition 3 is removed. A height D of FIG. 16A indicates a height by which the conductive film 55 is removed. The conductive film 55 in the upper portion of the side wall 25 of the partition 3 can be removed by use of, for example, the diamond blade. The conductive film 55 in the upper portion of the side wall 25 of the partition 3 is removed through cutting (grinding) by use of the diamond blade or the like while the position is adjusted by a stage (not shown).

Note that, it is also possible to remove an unnecessary portion of the conductive film 55 existing on the side wall 25 of the partition 3 by using a laser beam or the like. As the laser beam, for example, an excimer laser or a KrF laser is used. The laser beam has an energy density of, for example, about 1 J/cm² to 10 J/cm². Through scanning with the laser beam at an appropriate speed, the unnecessary portion of the conductive film 55 can be removed.

In this way, the unnecessary portion of the conductive film formed on the surface of the piezoelectric plate 12 is removed to form the electrode 21a in a desired shape.

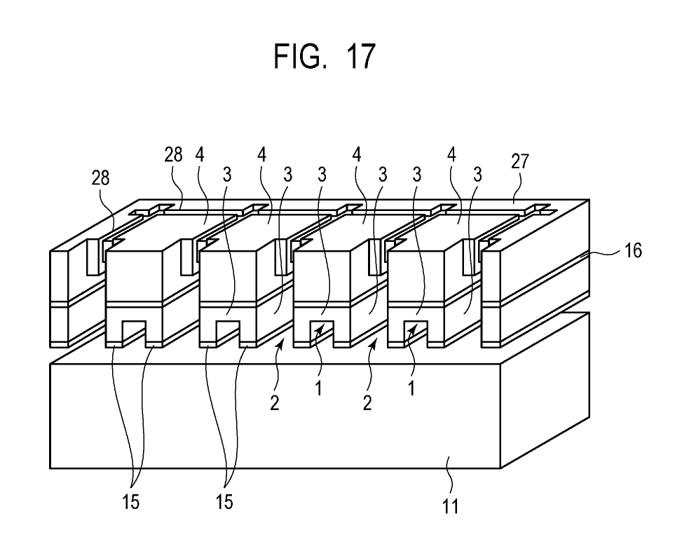

Then, as illustrated in FIG. 17, the cover plate (top) 11 is mounted onto the piezoelectric plate 12. It is preferred to use, as a material of the cover plate 11, for example, a material having a thermal expansion coefficient equivalent to that of the piezoelectric plate 12. In this case, as the material of the cover plate 11, the same material as that of the piezoelectric plate 12 is used. In this case, as the material of the cover plate 11, for example, PZT is used. Note that, the material of the cover plate 11 is not limited to the same material as that of the piezoelectric plate 12. As the material of the cover plate 11, a ceramics material such as alumina may also be used. One principal surface (surface on the lower side of the drawing sheet of FIG. 17) of the piezoelectric plate 12 and one principal surface (surface on the upper side of the drawing sheet of FIG. 17) of the cover plate 11 are bonded together with, for example, the epoxy-based adhesive layer 15. The grooves 1 and 2 are sealed by the cover plate 11, and hence the pressure chamber 1 is formed along the longitudinal direction of the grooves 1 and 2.

Subsequently, the front surface side, the back surface side, and the like of the piezoelectric plate 12 are subjected to grinding, polishing, and the like, to thereby remove the conductive film 55 from the piezoelectric plate 12 and adjust the external shape and dimensions.

Subsequently, the separating groove (not shown) 28 is appropriately formed in one principal surface (surface on the upper side of the drawing sheet of FIG. 17) of the piezoelectric plate 12. The separating groove 28 is formed for the purpose of separating the extracting electrodes 4 from one another. The separating groove 28 can be formed by, for example, scanning with a laser beam. As the laser beam, for example, an excimer laser or a KrF laser is used. Note that, the separating groove 28 can be formed by processing using the diamond blade or the like

After that, the manifold 40 is mounted on the back surface side of the piezoelectric transducer 10 (see FIG. 1). The manifold 40 has the common liquid chamber 43 (see FIG. 2) formed therein for supplying liquid to the pressure chambers 1 in the piezoelectric transducer 10. Liquid stored in a liquid bottle (not shown) is supplied into the manifold 40 through the ink supply port 41 formed on the back surface side of the manifold 40. Further, the ink discharge port 42 is also formed in the manifold 40. The ink supply port 41 and the ink discharge port 42 are formed in the manifold 40, which allows the ink to be circulated in the manifold 40.

Further, the orifice plate 60 is mounted on the front surface side of the piezoelectric plate 12 (see FIG. 1). The orifice plate 60 can be formed as described below. First, a plate-like substance for forming the orifice plate 60 is prepared. As a material of such a plate-like substance, for example, plastic is used. In this case, as the material of the plate-like substance, for example, a polyimide is used. Then, an ink-repellent film (not shown) is formed on a first principal surface that is one principal surface of the plate-like substance. The first principal surface of the plate-like substance is the principal surface that is opposite to a principal surface (second principal surface) that is opposed to the piezoelectric plate 12 when the orifice plate 60 is mounted to the piezoelectric plate 12. As a material of the ink-repellent film, for example, an amorphous fluorine resin manufactured by ASAHI GLASS CO., LTD. (trade name: CYTOP) is used. Then, a laser beam is radiated to the plate-like substance to form holes in the plate-like substance, to thereby form the nozzles 60a. When the holes are formed in the plate-like substance, the laser beam is radiated in a direction from the second principal surface side to the first principal surface side of the plate-like substance. As the laser beam, for example, an excimer laser is used. The holes formed in the plate-like substance become smaller from the second principal surface side toward the first principal surface side of the plate-like substance. The nozzles 60a are formed at positions corresponding to those of the pressure chambers (liquid channels) 1, respectively. In this way, the orifice plate 60 having the nozzles 60a formed therein is obtained. The orifice plate 60 is bonded to the end surface (bonded surface) of the piezoelectric plate 12 on the front surface side using, for example, an epoxy-based adhesive (not shown).

Further, the flexible substrate 50 is mounted to one principal surface (surface on the upper side of the drawing sheet of FIG. 1) of the piezoelectric plate 12 (see FIG. 1). The plurality of signal lines 51 are formed on the flexible substrate 50. The flexible substrate 50 and the piezoelectric plate 12 are aligned, and the flexible substrate 50 and the piezoelectric plate 12 are bonded together by thermocompression bonding, for example.

In this way, the liquid ejection device according to this embodiment is manufactured.

### Modification Example (Part 1)

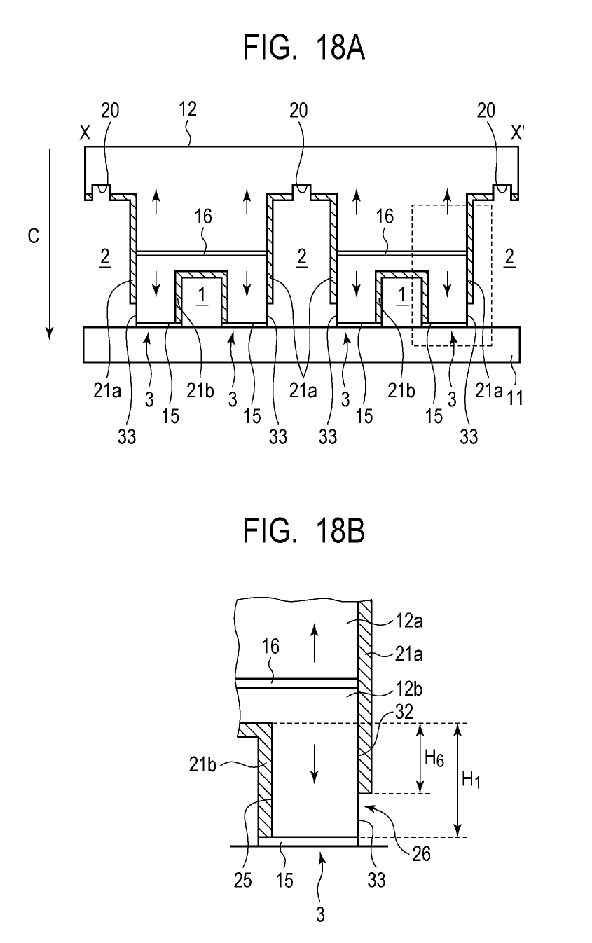

Next, a liquid ejection device according to Modification Example (Part 1) of this embodiment is described with reference to FIG. 18A and FIG. 18B. FIG. 18A and FIG. 18B are sectional views for illustrating parts of a piezoelectric transducer of the liquid ejection device according to this modification example. FIG. 18A corresponds to an X-X′ cross section of FIG. 3. Specifically, FIG. 18A is a view for illustrating a cross section of the region 18 on the front surface side of the piezoelectric transducer 10. FIG. 18B is an enlarged view of a part surrounded by the broken line of FIG. 18A.

In the liquid ejection device according to this modification example, in the region 18 on the front surface side of the piezoelectric transducer 10, the upper end of the electrode 21a is positioned below the upper surface of the partition 3.

As illustrated in FIGS. 18A and 18B, in the region 18 on the front surface side of the piezoelectric transducer 10, the electrode 21a is not formed on a wall surface 33 positioned in the upper portion of the partition 3, and the electrode 21a is formed on a wall surface 32 positioned below the wall surface 33. Here, for the sake of convenience of description, the description is made on the assumption that the upper side of the drawing sheets of FIG. 18A and FIG. 18B is the lower side and that the lower side of the drawing sheets of FIG. 18A and FIG. 18B is the upper side. In the region 18 on the front surface side of the piezoelectric transducer 10, a height (height from the bottom surface of the groove 1 to the upper end of the electrode 21a) H₆ of the electrode 21a is set to, for example, about half as much as the height (height from the bottom surface of the groove 1 to the upper surface of the partition 3) H₁ of the partition 3. Note that, the height H₆ of the electrode 21a is not limited thereto, and can be set appropriately so as to allow the partition 3 to be sufficiently displaced.

The electrode 21b is formed on the side wall 25 of the partition 3 and the bottom surface of the groove 1. The height (height from the bottom surface of the groove 1 to the upper end of the electrode 21b) of the electrode 21b is set, for example, to be the same as the height (height from the bottom surface of the groove 1 to the upper surface of the partition 3) H₁ of the partition 3. Specifically, in this modification example, the upper end of the electrode 21b is not positioned below the upper surface of the partition 3.

In the region 19 on the back surface side of the piezoelectric transducer 10, this modification example has the same structure as the structure described above with reference to FIG. 6A and FIG. 6B.

In this way, in the region 18 on the front surface side of the piezoelectric transducer 10, the upper end of the electrode 21a may be positioned below the upper surface of the partition 3. Also in this modification example, in the same manner as in the liquid ejection device according to the embodiment, the partition 3 can be displaced in the region 18 on the front surface side of the piezoelectric transducer 10.

Next, a method of manufacturing a liquid ejection device according to this modification example is described with reference to FIG. 16B. FIG. 16B is a process view for illustrating the method of manufacturing a liquid ejection device according to this modification example.

A step of forming the piezoelectric plate 12 to a step of forming the separating grooves 20 and 28 are the same as those of the method of manufacturing a liquid ejection device described above with reference to FIG. 12 to FIG. 15, and hence descriptions thereof are omitted.

Subsequently, as illustrated in FIG. 16B, a part of the conductive film 55 existing in the region 18 on the front surface side of the piezoelectric plate 12 is removed. Specifically, the conductive film 55 in the upper portion on the side wall 26 of the partition 3 is removed. The conductive film 55 positioned in the upper portion of the side wall 26 of the partition 3 can be removed by use of, for example, the diamond blade or the laser beam.

The subsequent steps of the method of manufacturing a liquid ejection device are the same as those of the method of manufacturing a liquid ejection device according to the embodiment described above, and hence descriptions thereof are omitted.

In this way, the liquid ejection device according to this modification example is manufactured.

### Modification Example (Part 2)

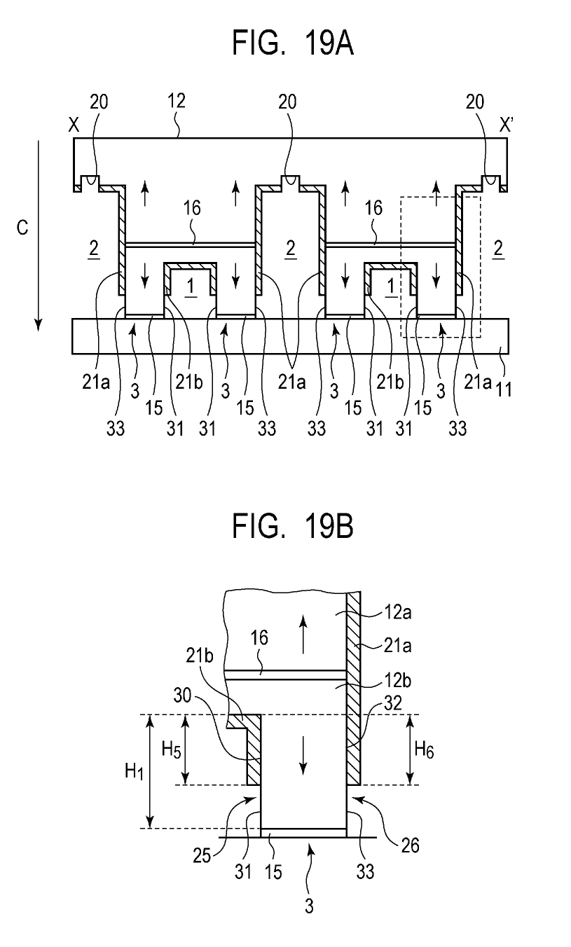

Next, a liquid ejection device according to Modification Example (Part 2) of this embodiment is described with reference to FIG. 19A and FIG. 19B. FIG. 19A and FIG. 19B are sectional views for illustrating parts of a piezoelectric transducer of the liquid ejection device according to this modification example. FIG. 19A corresponds to an X-X′ cross section of FIG. 3. Specifically, FIG. 19A is a view for illustrating a cross section of the region 18 on the front surface side of the piezoelectric transducer 10. FIG. 19B is an enlarged view of a part surrounded by the broken line of FIG. 19A.

In the liquid ejection device according to this modification example, in the region 18 on the front surface side of the piezoelectric transducer 10, the upper end of the electrode 21b is positioned below the upper surface of the partition 3, and the upper end of the electrode 21a is also positioned below the upper surface of the partition 3.

As illustrated in FIGS. 19A and 19B, in the region 18 on the front surface side of the piezoelectric transducer 10, the electrode 21b is not formed on the wall surface 31 positioned in the upper portion of the partition 3, and the electrode 21b is formed on the wall surface 30 positioned below the wall surface 31. Here, for the sake of convenience of description, the description is made on the assumption that the upper side of the drawing sheets of FIG. 19A and FIG. 19B is the lower side and that the lower side of the drawing sheets of FIG. 19A and FIG. 19B is the upper side. In the region 18 on the front surface side of the piezoelectric transducer 10, the height (height from the bottom surface of the groove 1 to the upper end of the electrode 21a) H₅ of the electrode 21b is set to, for example, about half as much as the height (height from the bottom surface of the groove 1 to the upper surface of the partition 3) H₁ of the partition 3. Note that, the height H₅ of the electrode 21b is not limited thereto, and can be set appropriately so as to allow the partition 3 to be sufficiently displaced.

In the region 18 on the front surface side of the piezoelectric transducer 10, the electrode 21a is not formed on the wall surface 33 positioned in the upper portion of the partition 3, and the electrode 21a is formed on the wall surface 32 positioned below the wall surface 33. In the region 18 on the front surface side of the piezoelectric transducer 10, the height (height from the bottom surface of the groove 1 to the upper end of the electrode 21a) H₆ of the electrode 21a is set to, for example, about half as much as the height (height from the bottom surface of the groove 1 to the upper surface of the partition 3) H₁ of the partition 3. Note that, the height H₆ of the electrode 21a is not limited thereto, and can be set appropriately so as to allow the partition 3 to be sufficiently displaced.

In the region 19 on the back surface side of the piezoelectric transducer 10, this modification example has the same structure as the structure described above with reference to FIG. 6A and FIG. 6B.

In this way, in the region 18 on the front surface side of the piezoelectric transducer 10, the upper end of the electrode 21b is positioned below the upper surface of the partition 3, and the upper end of the electrode 21a may also be positioned below the upper surface of the partition 3. Also in this modification example, in the same manner as in the liquid ejection device according to the embodiment, the partition 3 can be displaced in the region 18 on the front surface side of the piezoelectric transducer 10.

Next, a method of manufacturing a liquid ejection device according to this modification example is described with reference to FIG. 16C. FIG. 16C is a process view for illustrating the method of manufacturing a liquid ejection device according to this modification example.

A step of forming the piezoelectric plate 12 to a step of forming the separating grooves 20 and 28 are the same as those of the method of manufacturing a liquid ejection device described above with reference to FIG. 12 to FIG. 15, and hence descriptions thereof are omitted.

Subsequently, as illustrated in FIG. 16C, a part of the conductive film 55 existing in the region 18 on the front surface side of the piezoelectric plate 12 is removed. Specifically, the conductive film 55 in the upper portion on the side wall 25 of the partition 3 is removed. Further, the conductive film 55 in the upper portion on the side wall 26 of the partition 3 is removed. The conductive film 55 positioned in each of the upper portions of the side walls 25 and 26 of the partition 3 can be removed by use of, for example, the diamond blade or the laser beam.

The subsequent steps of the method of manufacturing a liquid ejection device are the same as those of the method of manufacturing a liquid ejection device according to the embodiment described above, and hence descriptions thereof are omitted.

### Modification Example (Part 3)

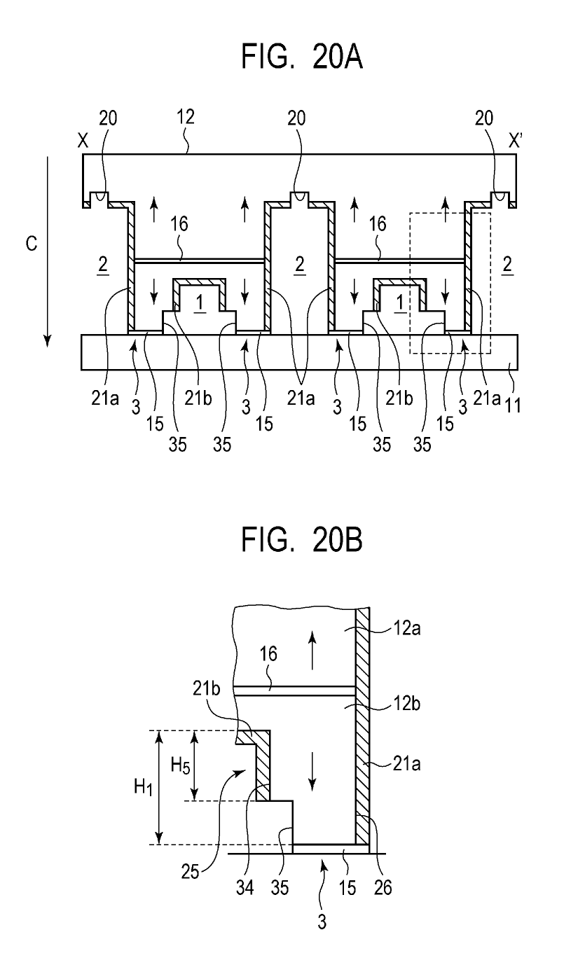

Next, a liquid ejection device according to Modification Example (Part 3) of this embodiment is described with reference to FIG. 20A and FIG. 20B. FIG. 20A and FIG. 20B are sectional views for illustrating parts of a piezoelectric transducer of the liquid ejection device according to this modification example. FIG. 20A corresponds to an X-X′ cross section of FIG. 3. Specifically, FIG. 20A is a view for illustrating a cross section of the region 18 on the front surface side of the piezoelectric transducer 10. FIG. 20B is an enlarged view of a part surrounded by the broken line of FIG. 20A.

In the liquid ejection device according to this modification example, in the region 18 on the front surface side of the piezoelectric transducer 10, the thickness of the partition 3 in the upper portion is set to be smaller than the thickness of the partition 3 in the lower portion.

As illustrated in FIGS. 20A and 20B, in this modification example, in the region 18 on the front surface side of the piezoelectric transducer 10, the thickness of the partition 3 on a top portion side is set to be small. More specifically, a wall surface 35 positioned in the upper portion of the partition 3 is recessed with respect to a wall surface 34 positioned below the wall surface 35 in a direction of a normal to the wall surface 35. Here, for the sake of convenience of description, the description is made on the assumption that the lower side of the drawing sheets of FIG. 20A and FIG. 20B is the upper side and that the upper side of the drawing sheets of FIG. 20A and FIG. 20B is the lower side.

The electrode 21b is formed on the wall surface 34, but is not formed on the wall surface 35. The height of the upper end of the electrode 21b is set to be the same as the height of an upper end of the wall surface 34.

In other words, a wall surface (side surface) positioned in the upper portion (predetermined range from the end surface (surface to be bonded to the cover plate) of the first partition portion) of the partition 3 in the region 18 on the front surface side of the piezoelectric transducer 10 is set to be smaller in thickness than a partition portion within a range other than the predetermined range.

The first partition portion within the predetermined range, which is only a little thinner than the first partition portion within a range other than the predetermined range, is effective. It is preferred that the thickness of the first partition portion within the predetermined range be as small as 45% or more and 99% or less of the thickness of the first partition portion within the range other than the predetermined range because a strength of the first partition portion is adversely affected with a thickness less than 45%.

In the region 19 on the back surface side of the piezoelectric transducer 10, this modification example has the same structure as the structure described above with reference to FIG. 6A and FIG. 6B.

In this way, in the region 18 on the front surface side of the piezoelectric transducer 10, the wall surface 35 positioned in the upper portion of the side wall 25 of the partition 3 may be recessed with respect to the wall surface 34 positioned below the wall surface 35 in the direction of the normal to the wall surface 35. Also in this modification example, in the same manner as in the liquid ejection device according to the embodiment, the partition 3 can be displaced in the region 18 on the front surface side of the piezoelectric transducer 10.

Next, a method of manufacturing a liquid ejection device according to this modification example is described with reference to FIG. 16A.

A step of forming the piezoelectric plate 12 to a step of forming the separating grooves 20 and 28 are the same as those of the method of manufacturing a liquid ejection device described above with reference to FIG. 12 to FIG. 15, and hence descriptions thereof are omitted.

Subsequently, as illustrated in FIG. 16A, the upper portion of the side wall 25 in the region 18 on the front surface side of the piezoelectric plate 12 is partially ground to be removed. This causes the wall surface 35 positioned in the upper portion of the side wall 25 of the partition 3 to be recessed with respect to the wall surface 34 positioned below the wall surface 35 in the direction of the normal to the wall surface 35 (see FIG. 20B). The upper portion of the side wall 25 of the partition 3 can be partially ground to be removed by use of, for example, the diamond blade.

The subsequent steps of the method of manufacturing a liquid ejection device are the same as those of the method of manufacturing a liquid ejection device according to the embodiment described above, and hence descriptions thereof are omitted.

### Modification Example (Part 4)

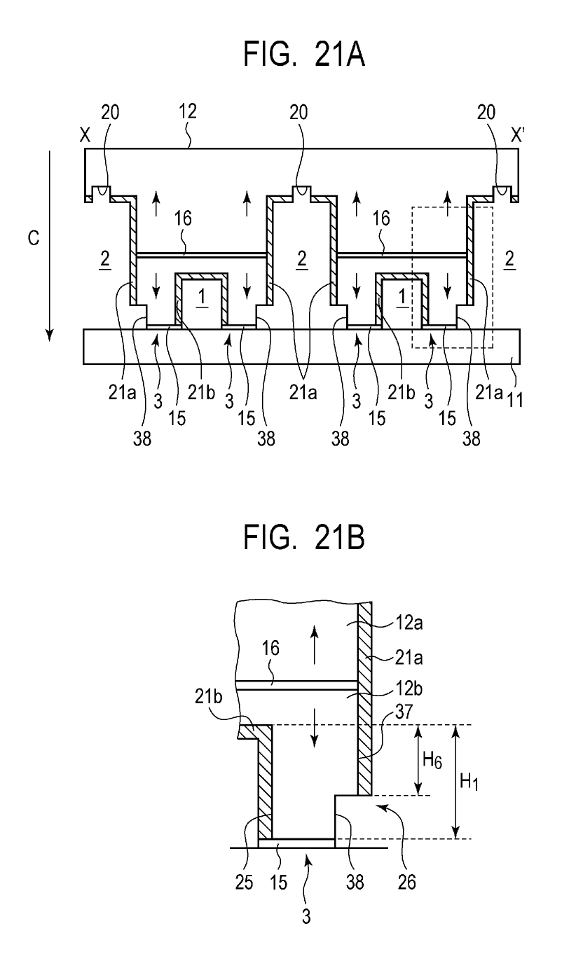

Next, a liquid ejection device according to Modification Example (Part 4) of this embodiment is described with reference to FIG. 21A and FIG. 21B. FIG. 21A and FIG. 21B are sectional views for illustrating parts of a piezoelectric transducer of the liquid ejection device according to this modification example. FIG. 21A corresponds to an X-X′ cross section of FIG. 3. Specifically, FIG. 21A is a view for illustrating a cross section of the region 18 on the front surface side of the piezoelectric transducer 10. FIG. 21B is an enlarged view of a part surrounded by the broken line of FIG. 21A.

In the liquid ejection device according to this modification example, as illustrated in FIGS. 21A and 21B, in the region 18 on the front surface side of the piezoelectric transducer 10, a wall surface 38 positioned in the upper portion of the side wall 26 of the partition 3 is recessed with respect to a wall surface 37 positioned below the wall surface 38 in a direction of a normal to the wall surface 38. Therefore, the thickness of the partition 3 in the upper portion is set to be smaller than the thickness of the partition 3 in the lower portion. Here, for the sake of convenience of description, the description is made on the assumption that the lower side of the drawing sheets of FIG. 21A and FIG. 21B is the upper side and that the upper side of the drawing sheets of FIG. 21A and FIG. 21B is the lower side.

The electrode 21a is formed on the wall surface 37, but is not formed on the wall surface 38. The height of the upper end of the electrode 21a is set to be the same as the height of an upper end of the wall surface 37.

In the region 19 on the back surface side of the piezoelectric transducer 10, this modification example has the same structure as the structure described above with reference to FIG. 6A and FIG. 6B.

In this way, in the region 18 on the front surface side of the piezoelectric transducer 10, the wall surface 38 positioned in the upper portion of the partition 3 may be recessed with respect to the wall surface 37 positioned below the wall surface 38 in the direction of the normal to the wall surface 38. Also in this modification example, in the same manner as in the liquid ejection device according to the embodiment, the partition 3 can be displaced in the region 18 on the front surface side of the piezoelectric transducer 10.

Next, a method of manufacturing a liquid ejection device according to this modification example is described with reference to FIG. 16B.

A step of forming the piezoelectric plate 12 to a step of forming the separating grooves 20 and 28 are the same as those of the method of manufacturing a liquid ejection device described above with reference to FIG. 12 to FIG. 15, and hence descriptions thereof are omitted.

Subsequently, as illustrated in FIG. 16B, the upper portion of the side wall 26 in the region 18 on the front surface side of the piezoelectric plate 12 is partially ground to be removed. This causes the wall surface 38 positioned in the upper portion of the side wall 26 of the partition 3 to be recessed with respect to the wall surface 37 positioned below the wall surface 38 in the direction of the normal to the wall surface 38 (see FIG. 21B). The upper portion of the side wall 26 of the partition 3 can be partially ground to be removed by use of, for example, the diamond blade.

The subsequent steps of the method of manufacturing a liquid ejection device are the same as those of the method of manufacturing a liquid ejection device according to the embodiment described above, and hence descriptions thereof are omitted.

### Modification Example (Part 5)

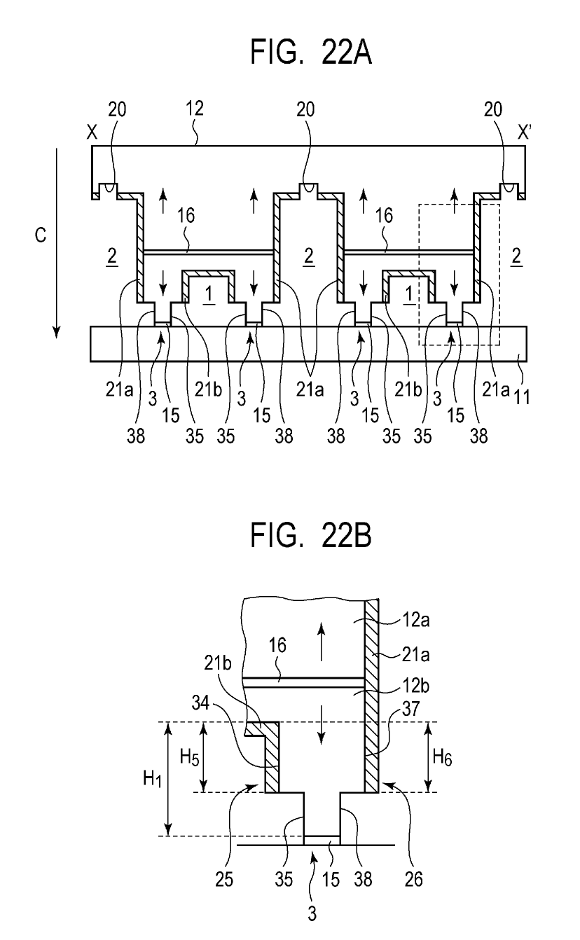

Next, a liquid ejection device according to Modification Example (Part 5) of this embodiment is described with reference to FIG. 22A and FIG. 22B. FIG. 22A and FIG. 22B are sectional views for illustrating parts of a piezoelectric transducer of the liquid ejection device according to this modification example. FIG. 22A corresponds to an X-X′ cross section of FIG. 3. Specifically, FIG. 22A is a view for illustrating a cross section of the region 18 on the front surface side of the piezoelectric transducer 10. FIG. 22B is an enlarged view of a part surrounded by the broken line of FIG. 22A.

In the liquid ejection device according to this modification example, in the region 18 on the front surface side of the piezoelectric transducer 10, the wall surfaces 35 and 38 positioned in the upper portions of the side walls 25 and 26 of the partition 3 are recessed with respect to the wall surfaces 34 and 37 positioned below the wall surfaces 35 and 38 in the normal directions of the wall surfaces 35 and 38, respectively. Therefore, in this modification example, the thickness of the partition 3 in the upper portion is sufficiently smaller than the thickness of the partition 3 in the lower portion. Here, for the sake of convenience of description, the description is made on the assumption that the lower side of the drawing sheets of FIG. 22A and FIG. 22B is the upper side and that the upper side of the drawing sheets of FIG. 22A and FIG. 22B is the lower side.

The electrode 21b is formed on the wall surface 34, but is not formed on the wall surface 35. The height of the upper end of the electrode 21b is set to be the same as the height of the upper end of the wall surface 34. The electrode 21a is formed on the wall surface 37, but is not formed on the wall surface 38. The height of the upper end of the electrode 21a is set to be the same as the height of the upper end of the wall surface 37.

In the region 19 on the back surface side of the piezoelectric transducer 10, this modification example has the same structure as the structure described above with reference to FIG. 6A and FIG. 6B.

In this way, in the region 18 on the front surface side of the piezoelectric transducer 10, the wall surfaces 35 and 38 positioned in the upper portions of the side walls 25 and 26 of the partition 3 may be recessed with respect to the wall surfaces 34 and 37 positioned below the wall surfaces 35 and 38 in the direction of the normal to the wall surfaces 35 and 38, respectively. Also in this modification example, in the same manner as in the liquid ejection device according to the embodiment, the partition 3 can be displaced in the region 18 on the front surface side of the piezoelectric transducer 10.

Next, a method of manufacturing a liquid ejection device according to this modification example is described with reference to FIG. 16C.

A step of forming the piezoelectric plate 12 to a step of forming the separating grooves 20 and 28 are the same as those of the method of manufacturing a liquid ejection device described above with reference to FIG. 12 to FIG. 15, and hence descriptions thereof are omitted.

Subsequently, as illustrated in FIG. 16C, the upper portions of the side walls 25 and 26 in the region 18 on the front surface side of the piezoelectric plate 12 are each partially ground to be removed. This causes the wall surface 35 positioned in the upper portion of the side wall 25 of the partition 3 to be recessed with respect to the wall surface 34 positioned below the wall surface 35 in the direction of the normal to the wall surface 35 (see FIG. 22B). Further, the wall surface 38 positioned in the upper portion of the side wall 26 of the partition 3 is recessed with respect to the wall surface 37 positioned below the wall surface 38 in the direction of the normal to the wall surface 38. The upper portions of the side walls 25 and 26 of the partition 3 can be partially ground to be removed by use of, for example, the diamond blade.

The subsequent steps of the method of manufacturing a liquid ejection device are the same as those of the method of manufacturing a liquid ejection device according to the embodiment described above, and hence descriptions thereof are omitted.

Note that, the present invention is not limited to the above-mentioned embodiment. Changes can be made thereto appropriately by a person who has common knowledge in this technical field within the scope that does not depart from the technical thought of the present invention.

Further, in the above-mentioned embodiment, the inkjet head to be used for a printer or the like is described as an example of the liquid ejection device, but the present invention is not limited thereto. For example, the liquid ejection device may be a liquid ejection device configured to eject liquid containing metal fine particles. When the liquid containing metal fine particles is ejected, it is possible to form metal wiring (metal pattern) or the like. Further, the liquid ejection device may be a liquid ejection device configured to eject resist liquid (resist ink). When the resist liquid is ejected, it is possible to form a resist pattern.

### EXAMPLES

Next, more specific examples of the present invention are described.

### Example 1

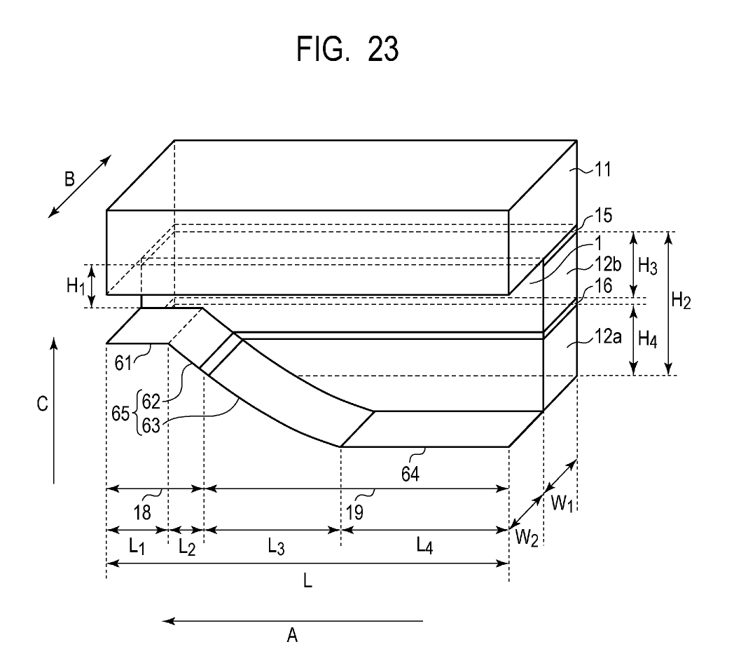

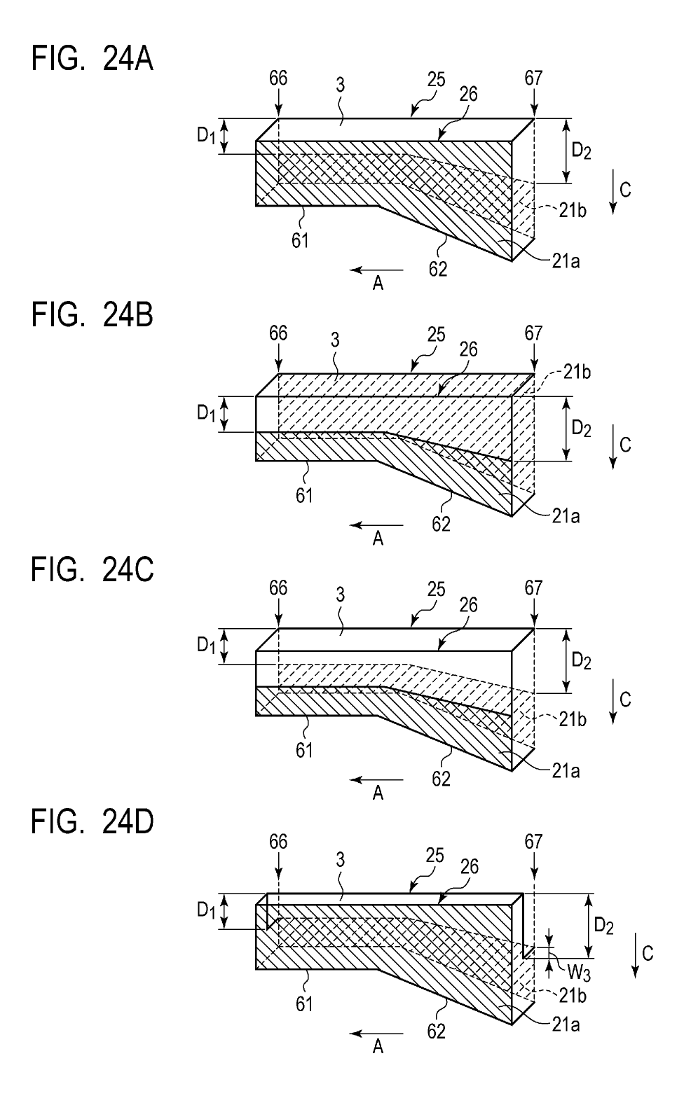

First, Example 1 is described with reference to FIG. 23 and FIG. 24A. Example 1 corresponds to the liquid ejection device according to the embodiment described above with reference to FIG. 1 to FIG. 17. FIG. 23 is a perspective view for illustrating a part of the piezoelectric transducer of the liquid ejection device according to the embodiment of the present invention. FIG. 24A is a perspective view for illustrating a part of a piezoelectric transducer of the liquid ejection device according to Example 1.

In Example 1, the groove 1 was formed by being subjected to processing using the diamond blade. Therefore, in Example 1, the pressure chamber 1 was set to partially have a tapered shape. In Example 1, a flat portion 61 that is a part having a flat bottom surface of the pressure chamber 1 was formed in the region 18 on the front surface side (left side of the drawing sheet of FIG. 23) of the piezoelectric transducer 10. Further, in Example 1, a flat portion 64 that is a part having a flat bottom surface of the pressure chamber 1 was formed in the region 19 other than the region 18 on the front surface side of the piezoelectric transducer 10, that is, in the region 19 of the back surface side of the piezoelectric transducer 10 (right side of the drawing sheet of FIG. 23). Further, in Example 1, a tapered portion 65 that is a part having a tapered bottom surface of the pressure chamber 1 was formed between the flat portion 61 and the flat portion 64. In Example 1, a partial tapered portion 62 that is a part of the tapered portion 65 is positioned in the region 18 on the front surface side of the piezoelectric transducer 10. On the other hand, in Example 1, a partial tapered portion 63 that is another part of the tapered portion 65 is positioned in the region 19 on the back surface side of the piezoelectric transducer 10.

In Example 1, a dimension L of the pressure chamber 1 in the longitudinal direction, that is, a length L of the pressure chamber 1 was set to 8 mm. Further, in Example 1, a length L₁ of the flat portion 61 in the region 18 on the front surface side of the piezoelectric transducer 10 was set to 0.5 mm. Further, in Example 1, a length L₂ of the partial tapered portion 62 in the region 18 on the front surface side of the piezoelectric transducer 10 was set to 1.1 mm. Further, in Example 1, a length L₃ of the partial tapered portion 63 in the region 19 on the back surface side of the piezoelectric transducer 10 was set to 2.8 mm. Further, in Example 1, a length L₄ of the flat portion 64 in the region 19 on the back surface side of the piezoelectric transducer 10 was set to 3.6 mm.

The direction indicated by the arrow C of FIG. 23 corresponds to a height direction. In Example 1, a height H₁ from the bottom surface of the pressure chamber 1 to the upper surface of the partition 3 in the flat portion 61 in the region 18 on the front surface side of the piezoelectric transducer 10 was set to 100 μm. Further, in Example 1, a height H₂ from the bottom surface of the pressure chamber 1 to the upper surface of the partition 3 in the flat portion 64 in the region 19 on the back surface side of the piezoelectric transducer 10 was set to 300 μm. Further, in Example 1, a height H₄ from the bottom surface of the pressure chamber 1 to the upper surface of the piezoelectric member 12a in the flat portion 64 in the region 19 on the back surface side of the piezoelectric transducer was set to 150 μm. Further, in Example 1, a height H₃ of the piezoelectric member 12b in the flat portion 64 in the region 19 on the back surface side of the piezoelectric transducer 10 was set to 150 μm. Further, in Example 1, the thicknesses of the adhesive layers 15 and 16 were set to about 2 μm.

Further, in Example 1, a dimension W₁ of the partition 3 in a direction indicated by an arrow B of FIG. 23, that is, a width (thickness) W₁ of the partition 3 was set to 60 μm. Further, in Example 1, a dimension W₂ of the pressure chamber 1 in the direction indicated by the arrow B of FIG. 23, that is, the width W₂ of the pressure chamber 1 was set to 60 μm.

FIG. 24A to FIG. 24D are perspective views for illustrating parts of the piezoelectric transducer of the liquid ejection device according to Example 1 to Example 4, respectively. The partition 3 in the region 18 on the front surface side of the piezoelectric transducer 10 is illustrated in FIG. 24A to FIG. 24D.

In Example 1, as illustrated in FIG. 24A, the electrodes 21a and 21b were each formed.

Specifically, in Example 1, the upper end of the electrode 21a formed on the one side wall 26 of the partition 3 was made to be matched in level with the upper surface of the partition 3.

On the other hand, in Example 1, the upper end of the electrode 21b formed on the other side wall 25 of the partition 3 was recessed downward from the upper surface of the partition 3. In the flat portion 61, the upper portion of the electrode 21b was removed by a height D₁. The height D₁ by which the electrode 21b was removed, that is, the dimension D₁ between the upper surface of the partition 3 and the upper end of the electrode 21b was set to 50 μm that is half as much as the height H₁ from the bottom surface of the pressure chamber 1 to the upper surface of the partition 3 in the flat portion 61. In the tapered portion 62, the upper portion of the electrode 21b was removed by an increasing height. At a boundary 67 between the region 18 on the front surface side and the region 19 on the back surface side of the piezoelectric transducer 10, a height D₂ by which the upper portion of the electrode 21b is removed was set to 75 μm that is half as much as a height H₃ of the piezoelectric member 12b. The upper portion of the electrode 21b was removed by use of the laser beam.

After that, the cover plate 11 was mounted to the piezoelectric plate 12 processed in this manner, and then the manifold 40, the orifice plate 60, the flexible substrate 50, and the like were mounted to the piezoelectric transducer 10, to obtain the liquid ejection device according to Example 1.

The liquid ejection device according to Example 1 was caused to eject liquid to be evaluated. As the liquid to be ejected in the evaluation, an ethylene glycol solution diluted with water was used. A concentration of ethylene glycol within the liquid was set to 80 wt %. When the liquid is ejected from the liquid ejection device according to Example 1, voltages to be applied to the electrodes 21a and 21b were set as follows.

That is, the electrode 21b was set to have a potential of 0 V. On the other hand, a pulse-like signal having a positive voltage was applied to the electrode 21a. The signal to be applied to the electrode 21a was set to have a pulse width of 8 μs.

An image pickup apparatus to which a microscope was mounted was used to take an image of a liquid droplet in a flying state. As a light source used for taking the image of the liquid droplet in the flying state, a light source configured to emit nano-pulse laser light was used.

As the voltage of the pulse-like signal to be applied to the electrode 21a was increased, the speed of the liquid droplet increased. When the speed of the liquid droplet (main droplet) became equal to or more than a given speed, a minute liquid droplet (satellite droplet) separate from the main droplet was generated before the main droplet. The speed of the main droplet exhibited when the satellite droplet began to be generated differed depending on the diameters of the nozzles 60a. The speed of the main droplet exhibited when the satellite droplet began to be generated is shown in Table 1.

In Comparative Example, the liquid ejection device from which the upper portion of the electrode 21b was not removed was evaluated.

TABLE 1

| | Diameter of nozzle | | | | |
|---|---|---|---|---|---|
| | φ5 μm | φ7 μm | φ10 μm | φ12 μm | φ15 μm |
| Example 1 | 3 m/s | 4.5 m/s | 5.5 m/s | 7.5 m/s | 8.5 m/s |
| Comparative | 0.2 m/s | 0.5 m/s | 1.0 m/s | 3.0 m/s | 4.5 m/s |
| Example | | | | | |

As can be seen from Table 1, in Comparative Example, when the diameter of the nozzle 60a was set to be relatively small, the satellite droplet was generated even with a relatively low speed of the liquid droplet.

In contrast, in Example 1, even when the diameter of the nozzle 60a was relatively small and when the speed of the liquid droplet was relatively high, the satellite droplet was hardly generated.

In Comparative Example, it is conceivable that, when the diameter of the nozzle 60a is set to be relatively small, the satellite droplet is generated even when the speed of the liquid droplet is relatively low for the following reason. Specifically, in Comparative Example, in the region 18 on the front surface side of the piezoelectric transducer 10, the upper portions of the electrodes 21a and 21b are not removed. In addition, the upper surface of the partition 3 is fixed to the cover plate 11. Therefore, in Comparative Example, in the region 18 on the front surface side of the piezoelectric transducer 10, the partition 3 is not displaced. Therefore, in Comparative Example, when the partial pressure chamber 1a (see FIG. 11A to FIG. 11E) is contracted, the partial pressure chamber 1b is not expanded. Therefore, in Comparative Example, when the partial pressure chamber 1a is contracted, the pressure of the liquid suddenly concentrates into the nozzle 60a. Therefore, in Comparative Example, it is conceivable that, when the diameter of the nozzle 60a becomes relatively small, the satellite droplet is generated even with a relatively low speed of the liquid droplet.

In Example 1, the upper portion of the electrode 21b is removed in the region 18 on the front surface side of the piezoelectric transducer 10, and hence the partition 3 can be displaced in the region 18 on the front surface side of the piezoelectric transducer 10. In Example 1, when the partial pressure chamber 1a is contracted, the partial pressure chamber 1b is expanded. Therefore, according to Example 1, it is possible to alleviate the concentration of the pressure of the liquid into the nozzle 60a. Therefore, according to Example 1, even when the diameter of the nozzle 60a is relatively small and when the speed of the liquid droplet is relatively high, it is possible to prevent the satellite droplet from being easily generated.

### Example 2

Next, Example 2 is described with reference to FIG. 23 and FIG. 24B. FIG. 24B is a perspective view for illustrating a part of a piezoelectric transducer of a liquid ejection device according to Example 2.

Example 2 corresponds to the liquid ejection device according to Modification Example (Part 1) described above with reference to FIG. 18A and FIG. 18B. Example 2 is different from Example 1 in that the upper portion of the electrode 21a was removed while the upper portion of the electrode 21b was removed in Example 1. Example 2 is the same as Example 1 except that the upper portion of the electrode 21a was removed and the upper portion of the electrode 21b was not removed.

In Example 2, as illustrated in FIG. 24B, the electrodes 21b and 21a were each formed.

Specifically, in Example 2, the upper end of the electrode 21b formed on the one side wall 25 of the partition 3 was made to be matched in level with the upper surface of the partition 3.

On the other hand, in Example 2, the upper end of the electrode 21a formed on the other side wall 26 of the partition 3 was positioned below the upper surface of the partition 3. In the flat portion 61, the upper portion of the electrode 21a was removed by the height D₁. The height D₁ by which the electrode 21a was removed, that is, the dimension D₁ between the upper surface of the partition 3 and the upper end of the electrode 21a was set to 50 μm that is half as much as the height H₁ from the bottom surface of the pressure chamber 1 to the upper surface of the partition 3 in the flat portion 61. In the tapered portion 62, the upper portion of the electrode 21a was removed by an increasing height. At the boundary 67 between the region 18 on the front surface side and the region 19 on the back surface side of the piezoelectric transducer 10, the height D₂ by which the upper portion of the electrode 21a is removed was set to 75 μm that is half as much as the height H₃ of the piezoelectric member 12b. The upper portion of the electrode 21a was removed by use of the laser beam.

The thus-obtained liquid ejection device according to Example 2 was evaluated in the same manner as in Example 1. The results of evaluation of the liquid ejection device according to Example 2 are shown in Table 2.

TABLE 2

| | Diameter of nozzle | | | | |
|---|---|---|---|---|---|
| | φ5 μm | φ7 μm | φ10 μm | φ12 μm | φ15 μm |
| Example 2 | 3.5 m/s | 4.0 m/s | 6.0 m/s | 7.0 m/s | 8.5 m/s |

As can be seen from a comparison between Table 1 and Table 2, also in Example 2, substantially the same performance as in Example 1 is obtained.

It is conceivable that the results of evaluation of Example 2 is substantially the same as the results of evaluation of Example 1 because a portion in which the upper portion of the electrode is removed is only changed from the side wall 25 side to the side wall 26 side without any change made to the displacement amount of the partition 3 itself.

### Example 3

Next, Example 3 is described with reference to FIG. 23 and FIG. 24C. FIG. 24C is a perspective view for illustrating a part of a piezoelectric transducer of a liquid ejection device according to Example 3.

Example 3 corresponds to the liquid ejection device according to Modification Example (Part 2) described above with reference to FIG. 19A and FIG. 19B. Example 3 is different from Examples 1 and 2 in that both the upper portion of the electrode 21a and the upper portion of the electrode 21b were removed while one of the upper portions of the electrodes 21a and 21b was removed in Examples 1 and 2. Example 3 is the same as Examples 1 and 2 except that both the upper portions of the electrodes 21a and 21b were removed.

In Example 3, as illustrated in FIG. 24C, the electrodes 21b and 21a were each formed.

Specifically, in Example 3, the upper ends of the electrodes 21a and 21b formed on the respective side walls 25 and 26 of the partition 3 were positioned below the upper surface of the partition 3. In the flat portion 61, the upper portions of the electrodes 21a and 21b were removed by the height D₁. The height D₁ by which the electrodes 21a and 21b were removed, that is, the dimension D₁ between the upper surface of the partition 3 and each of the upper ends of the electrodes 21a and 21b was set to 50 μm that is half as much as the height H₁ from the bottom surface of the pressure chamber 1 to the upper surface of the partition 3 in the flat portion 61. In the tapered portion 62, the upper portions of the electrodes 21a and 21b were removed by an increasing height. At the boundary 67 between the region 18 on the front surface side of the piezoelectric transducer 10 and the region 19 on the back surface side, the height D₂ by which the upper portions of the electrodes 21a and 21b are removed was set to 75 μm that is half as much as the height H₃ of the piezoelectric member 12b. The upper portions of the electrodes 21a and 21b were removed by use of the laser beam.

The thus-obtained liquid ejection device according to Example 3 was evaluated in the same manner as in Examples 1 and 2. The results of evaluation of the liquid ejection device according to Example 3 are shown in Table 3.

TABLE 3

| | Diameter of nozzle | | | | |
|---|---|---|---|---|---|
| | φ5 μm | φ7 μm | φ10 μm | φ12 μm | φ15 μm |
| Example 3 | 2.0 m/s | 3.0 m/s | 5.0 m/s | 6.0 m/s | 7.0 m/s |

As can be seen from comparisons between Table 3 and Tables 1 and 2, the speed of the main droplet exhibited when the satellite droplet began to be generated dropped in Example 3 compared to Examples 1 and 2.

It is conceivable that the speed of the main droplet exhibited when the satellite droplet began to be generated dropped in Example 3 because the displacement amount of the partition 3 in the region 18 on the front surface side of the piezoelectric transducer 10 was smaller in Example 3 than in Examples 1 and 2. The displacement amount of the partition 3 in the region 18 on the principal surface side of the piezoelectric transducer 10 reduces in Example 3 because the electric field applied to the partition 3 decreases when both the upper portions of the electrodes 21a and 21b are removed.

When the displacement amount of the partition 3 in the region 18 on the front surface side of the piezoelectric transducer 10 reduces, an expansion amount of the partial pressure chamber 1b exhibited when the partial pressure chamber 1a is contracted reduces. Therefore, in Example 3, the effect of alleviating the concentration of the pressure of the liquid into the nozzle 60a deteriorates. Therefore, it is conceivable that the speed of the main droplet exhibited when the satellite droplet began to be generated dropped in Example 3 compared to Examples 1 and 2.

### Example 4

Next, Example 4 is described with reference to FIG. 23 and FIG. 24D. FIG. 24D is a perspective view for illustrating a part of a piezoelectric transducer of a liquid ejection device according to Example 4.

Example 4 corresponds to the liquid ejection device according to Modification Example (Part 3) described above with reference to FIG. 20A and FIG. 20B. Example 4 is different from Example 1 in that the upper portion of the side wall 25 of the partition 3 was recessed in a direction of a normal to the side wall 25 while the upper portion of the side wall 25 of the partition 3 is not recessed in the direction of the normal to the side wall 25 in Example 1. Example 4 is the same as Example 1 except that the upper portion of the side wall 25 of the partition 3 was recessed in the direction of the normal to the side wall 25.

In Example 4, as illustrated in FIG. 24D, the electrodes 21b and 21a were each formed.

Specifically, in Example 4, the upper end of the electrode 21a formed on the one side wall 26 of the partition 3 was made to be matched in level with the upper surface of the partition 3.

On the other hand, in Example 4, the upper portion of the partition 3 was removed on the other side wall 25 side of the partition 3. This caused the wall surface 35 positioned in the upper portion of the side wall 25 (see FIG. 20A and FIG. 20B) to be recessed with respect to the wall surface 34 positioned below the wall surface 35 (see FIG. 20A and FIG. 20B) in the direction of the normal to the wall surface 35. An amount (dimension) W₃ by which the wall surface 35 was recessed with respect to the wall surface 34 in the direction of the normal to the wall surface 35 was set to 20 μm. When the upper portion of the partition 3 was removed on the side wall 25 side, the upper portion of the electrode 21b was also removed.

In the flat portion 61, the upper portion of the partition 3 on the side wall 25 side was removed by the height D₁. The dimension D₁ was set to 50 μm that is half as much as the height H₁ from the bottom surface of the pressure chamber 1 to the upper surface of the partition 3 in the flat portion 61. In the tapered portion 62, the height by which the upper portion of the electrode 21b is removed was gradually increased. At the boundary 67 between the region 18 on the front surface side and the region 19 on the back surface side of the piezoelectric transducer 10, the height D₂ by which the upper portion of the partition 3 was removed on the side wall 25 side was set to 75 μm that is half as much as the height H₃ of the piezoelectric member 12b. The upper portion of the partition 3 was removed on the side wall 25 side by use of the end mill.

The thus-obtained liquid ejection device according to Example 4 was evaluated in the same manner as in Example 1. The results of evaluation of the liquid ejection device according to Example 4 are shown in Table 4.

TABLE 4

| | Diameter of nozzle | | |
|---|---|---|---|
| | φ7 μm | φ10 μm | φ12 μm |
| Example 4 | 5.5 m/s | 6.5 m/s | 8.0 m/s |

As can be seen from Table 4, the speed of the main droplet exhibited when the satellite droplet began to be generated improved in Example 4 compared to Examples 1 and 2.

It is conceivable that the speed of the main droplet exhibited when the satellite droplet began to be generated improved in Example 4 because the displacement amount of the partition 3 in the region 18 on the front surface side of the piezoelectric transducer 10 was larger in Example 4 than in Examples 1 and 2. It is conceivable that the displacement amount of the partition 3 in the region 18 on the principal surface side of the piezoelectric transducer 10 increases in Example 4 because the rigidity of the partition 3 reduces with a smaller thickness of the partition 3 in the upper portion and the displacement amount of the partition 3 increases.

When the displacement amount of the partition 3 in the region 18 on the front surface side of the piezoelectric transducer 10 increases, an expansion amount of the partial pressure chamber 1b exhibited when the partial pressure chamber 1a is contracted increases. Therefore, in Example 4, the effect of alleviating the concentration of the pressure of the liquid into the nozzle 60a improves. Therefore, it is conceivable that the speed of the main droplet exhibited when the satellite droplet began to be generated improved in Example 4 compared to Examples 1 and 2.

### Example 5

Next, Example 5 is described with reference to FIG. 23 and FIG. 24A.

Example 5 corresponds to the liquid ejection device according to the embodiment described above with reference to FIG. 1 to FIG. 17. In Example 5, the heights D₁ and D₂ by which the upper portion of the electrode 21b was removed was changed from those of Example 1. Example 5 is the same as Example 1 except that the heights D₁ and D₂ by which the upper portion of the electrode 21b was removed was changed.

In Example 5, a ratio (D₁/H₁) of the height D₁ by which the upper portion of the electrode 21b was removed to the height H₁ from the bottom surface of the pressure chamber 1 in the region 18 on the front surface side of the piezoelectric transducer 10 to the upper surface of the partition 3 was changed from 0.2 to 0.8.

Further, in Example 5, a ratio (D₂/H₃) of the height D₂ by which the upper portion of the electrode 21b was removed to the height H₃ of the piezoelectric member 12b at the boundary 67 between the region 18 on the front surface side and the region 19 on the back surface side of the piezoelectric transducer 10 was changed from 0.2 to 0.8.

The thus-obtained liquid ejection device according to Example 5 was evaluated in the same manner as in Example 1. The results of evaluation of the liquid ejection device according to Example 5 are shown in Table 5.

TABLE 5

| D₁ | 20 | μm | 30 | μm | 35 | μm | 50 | μm | 65 | μm | 75 | μm | 80 | μm |
|---|---|---|---|---|---|---|---|---|---|---|---|---|---|---|
| D₁/H₁ | 0.2 | | 0.3 | | 0.35 | | 0.5 | | 0.65 | | 0.75 | | 0.8 | |
| D₂ | 30 | μm | 45 | μm | 50 | μm | 75 | μm | 100 | μm | 110 | μm | 120 | μm |
| D₂/H₃ | 0.2 | | 0.3 | | 0.33 | | 0.5 | | 0.66 | | 0.73 | | 0.8 | |
| Example 5 | 0.3 | m/s | 0.5 | m/s | 3.5 | m/s | 5.5 | m/s | 5.5 | m/s | 3 | m/s | 0.3 | m/s |

As can be seen from Table 5, when the heights D₁ and D₂ by which the upper portion of the electrode 21b is removed are excessively large or small, the speed of the main droplet exhibited when the satellite droplet begins to be generated drops.

It is conceivable that the speed of the main droplet exhibited when the satellite droplet begins to be generated drops when the heights D₁ and D₂ by which the upper portion of the electrode 21b is removed are excessively large, because the electric field applied to the partition 3 decreases when the heights D₁ and D₂ by which the upper portion of the electrode 21b is removed is set to be excessively high, to thereby decrease the displacement amount of the partition 3.

On the other hand, it is conceivable that the speed of the main droplet exhibited when the satellite droplet begins to be generated drops when the heights D₁ and D₂ by which the upper portion of the electrode 21b is removed are excessively small, because the electric field is also applied to the upper portion of the partition 3 in the same direction as the electric field applied to the lower portion of the partition 3, to thereby decrease the displacement amount of the partition 3.

As can be seen from Table 5, it is preferred that the heights D₁ and D₂ by which the upper portion of the electrode 21b is removed be 35% or more and 75% or less of the heights H₁ and H₃ of the partition 3. Specifically, it is preferred that the height from the bottom of the pressure chamber 1 in the region 18 on the front surface side of the piezoelectric transducer 10 to the upper end of the electrode 21b be 25% or more and 65% or less of the height from the bottom of the pressure chamber 1 in the region 18 on the front surface side of the piezoelectric transducer to the upper surface of the partition 3.

### Example 6

Next, Example 6 is described with reference to FIG. 23 and FIG. 24D.

Example 6 corresponds to the liquid ejection device according to Modification Example (Part 3) described above with reference to FIG. 20A and FIG. 20B. In Example 6, the recess amount (removal amount or dimension) W₃ of the wall surface 35 with respect to the wall surface 34 was changed from Example 4. Example 6 is the same as Example 4 except that the recess amount W₃ of the wall surface 35 with respect to the wall surface 34 was changed.

In Example 6, the thickness W₁ of the partition 3 in the lower portion of the partition 3 was set to 60 μm. In Example 6, a ratio (W₃/W₁) of the recess amount W₃ of the wall surface 35 to the thickness W₁ of the partition 3 in the lower portion of the partition 3 was changed from 0.16 to 0.66. In Example 6, the diameter of the nozzle 60a was set to φ10 μm.

The thus-obtained liquid ejection device according to Example 6 was evaluated in the same manner as in Example 1. The results of evaluation of the liquid ejection device according to Example 6 are shown in Table 6.

TABLE 6

| | | | | | | | | | | | | |
|---|---|---|---|---|---|---|---|---|---|---|---|---|
| W₃ | 10 | μm | 20 | μm | 25 | μm | 30 | μm | 35 | μm | 40 | μm |

| W₃/W₁ | 0.16 | | 0.33 | | 0.42 | | 0.5 | | 0.58 | | 0.66 |
|---|---|---|---|---|---|---|---|---|---|---|---|
| Example 6 | 6.0 | m/s | 6.5 | m/s | 6.5 | m/s | 7.0 | m/s | 7.5 | m/s | Process |
| | | | | | | | | | | | failure |

As can be seen from Table 6, the speed of the main droplet exhibited when the satellite droplet begins to be generated improves as the recess amount W₃ of the wall surface 35 with respect to the wall surface 34 is set to be larger.

It is conceivable that the speed of the main droplet exhibited when the satellite droplet begins to be generated improves as the recess amount W₃ of the wall surface 35 with respect to the wall surface 34 is set to be larger because, as the recess amount W₃ of the wall surface 35 with respect to the wall surface 34 is set to be larger, the rigidity of the partition 3 reduces and the displacement amount of the partition 3 increases.

On the other hand, when the recess amount W₃ of the wall surface 35 with respect to the wall surface 34 is set to be too large, such a failure that the partition 3 breaks at a process time occurs frequently.

In view of the foregoing, it is preferred that the ratio (W₃/W₁) of the recess amount W₃ of the wall surface 35 to the thickness W₁ of the partition 3 in the lower portion of the partition 3 be less than 55%. In other words, it is preferred that the thickness between the wall surface 35 and the side wall 26 in the region 18 on the front surface side of the piezoelectric transducer 10 be 45% or more of the thickness between the wall surface 34 and the side wall 26 in the region 18 on the front surface side of the piezoelectric transducer 10.

According to the present invention, in the region on the back surface side of the piezoelectric transducer, the bottom surface of the pressure chamber is positioned in the position deeper than the boundary between the first piezoelectric member and the second piezoelectric member. On the other hand, in the region on the front surface side of the piezoelectric transducer, the bottom surface of the pressure chamber is positioned in the position shallower than the boundary between the first piezoelectric member and the second piezoelectric member. Then, on the front surface side of the piezoelectric transducer, the upper end of the first electrode is positioned below the upper surface of the partition. Therefore, according to the present invention, in the region on the front surface side of the piezoelectric transducer, the partition can be displaced. Accordingly, when the pressure chamber is contracted in the region on the back surface side of the piezoelectric transducer, the pressure chamber is expanded in the region of the front surface side of the piezoelectric transducer. Therefore, according to the present invention, when the liquid droplet is ejected by contracting the region on the back surface side of the piezoelectric transducer, it is possible to alleviate the sudden concentration of pressure into the nozzle, which can inhibit the satellite droplet from being generated. Accordingly, according to the present invention, it is possible to provide a liquid ejection device that can eject a minute liquid droplet with stability.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-184808, filed Sep. 11, 2014 which is hereby incorporated by reference herein in its entirety.

1. A liquid ejection device, comprising:
a base including:
a first piezoelectric member; and
a second piezoelectric member fixed to the first piezoelectric member and polarized in a direction opposite to a polarization direction of the first piezoelectric member;
a pressure chamber formed in the base and separated by at least two partitions formed of the first piezoelectric member and the second piezoelectric member; and
an electrode formed on each of both side surfaces of the at least two partitions, wherein:
the pressure chamber is narrow on a front surface side on which a discharge port configured to eject liquid is formed;
a surface of the at least two partitions that faces the pressure chamber includes:
a first partition portion formed of only the first piezoelectric member; and
a second partition portion formed of the first piezoelectric member and the second piezoelectric member;
the pressure chamber is separated by the first partition portion on the front surface side;
the pressure chamber is separated by the second partition portion on a back surface side on which a liquid chamber configured to supply the liquid to the pressure chamber is formed;
the electrode formed on each of the both side surfaces of the at least two partitions includes a first electrode on the pressure chamber side and a second electrode on a side opposite to the pressure chamber side; and
a capacity of the pressure chamber facing the second partition portion increases, and a capacity of the pressure chamber facing the first partition portion decreases, at a time when a voltage is applied so that a potential of the first electrode becomes lower than a potential of the second electrode, compared to a time when a voltage is applied so that the potential of the first electrode becomes the same as the potential of the second electrode.

2. The liquid ejection device according to claim 1, wherein the capacity of the pressure chamber facing the second partition portion decreases, and the capacity of the pressure chamber facing the first partition portion increases, at a time when a voltage is applied so that the potential of the first electrode becomes higher than the potential of the second electrode, compared to the time when the voltage is applied so that the potential of the first electrode becomes the same as the potential of the second electrode.

3. A liquid ejection device, comprising:
a base including:
a first piezoelectric member; and
a second piezoelectric member fixed to the first piezoelectric member and polarized in a direction opposite to a polarization direction of the first piezoelectric member;
a pressure chamber formed in the base and separated by at least two partitions formed of the first piezoelectric member and the second piezoelectric member and by a plate mounted on end surfaces of the at least two partitions; and
an electrode formed on each of both side surfaces of the at least two partitions, wherein:
the pressure chamber is narrow on a front surface side on which a discharge port configured to eject liquid is formed;
a surface of the at least two partitions that faces the pressure chamber includes:
a first partition portion formed of only the first piezoelectric member; and
a second partition portion formed of the first piezoelectric member and the second piezoelectric member;
the pressure chamber is separated by the first partition portion on the front surface side;
the pressure chamber is separated by the second partition portion on a back surface side on which a liquid chamber configured to supply the liquid to the pressure chamber is formed; and
the electrode formed on at least one side surface of the first partition portion is formed within a range other than a predetermined range from the end surface.

4. The liquid ejection device according to claim 3, wherein a thickness of the first partition portion within the predetermined range is smaller than a thickness of the first partition portion within the range other than the predetermined range.

5. The liquid ejection device according to claim 3, wherein an area of the predetermined range is 35% or more and 75% or less of an area of a surface of the first partition portion facing the pressure chamber.

6. The liquid ejection device according to claim 4, wherein the thickness of the first partition portion within the predetermined range is 45% or more of the thickness of the first partition portion within the range other than the predetermined range.

7. A method of manufacturing a liquid ejection device, comprising:
forming a groove in a first piezoelectric member and a second piezoelectric member fixed to the first piezoelectric member and polarized in a direction opposite to a polarization direction of the first piezoelectric member, to thereby form a pressure chamber separated by a partition including a first partition portion obtained by cutting up to the first piezoelectric member and a second partition portion obtained by cutting from the first piezoelectric member up to the second piezoelectric member;
forming an electrode on the partition; and
removing the electrode formed on at least one side surface of the first partition portion and formed within a predetermined range from an end surface of the partition.

8. The method of manufacturing a liquid ejection device according to claim 7, wherein the removing the electrode comprises cutting.

9. A printer, comprising a liquid ejection device, the liquid ejection device including:
a base including:
a first piezoelectric member; and
a second piezoelectric member fixed to the first piezoelectric member and polarized in a direction opposite to a polarization direction of the first piezoelectric member;
a pressure chamber formed in the base and separated by at least two partitions formed of the first piezoelectric member and the second piezoelectric member; and
an electrode formed on each of both side surfaces of the at least two partitions, wherein:
the pressure chamber is narrow on a front surface side on which a discharge port configured to eject liquid is formed;
a surface of the at least two partitions that faces the pressure chamber includes:
a first partition portion formed of only the first piezoelectric member; and
a second partition portion formed of the first piezoelectric member and the second piezoelectric member;
the pressure chamber is separated by the first partition portion on the front surface side;
the pressure chamber is separated by the second partition portion on a back surface side on which a liquid chamber configured to supply the liquid to the pressure chamber is formed;
the electrode formed on each of the both side surfaces of the at least two partitions includes a first electrode on the pressure chamber side and a second electrode on a side opposite to the pressure chamber side; and
a capacity of the pressure chamber facing the second partition portion increases, and a capacity of the pressure chamber facing the first partition portion decreases, at a time when a voltage is applied so that a potential of the first electrode becomes lower than a potential of the second electrode, compared to a time when a voltage is applied so that the potential of the first electrode becomes the same as the potential of the second electrode.

10. A printer comprising a liquid ejection device, the liquid ejection device including:
a base including:
a first piezoelectric member; and
a second piezoelectric member fixed to the first piezoelectric member and polarized in a direction opposite to a polarization direction of the first piezoelectric member;
a pressure chamber formed in the base and separated by at least two partitions formed of the first piezoelectric member and the second piezoelectric member and by a plate mounted on end surfaces of the at least two partitions; and
an electrode formed on each of both side surfaces of the at least two partitions, wherein:
the pressure chamber is narrow on a front surface side on which a discharge port configured to eject liquid is formed;
a surface of the at least two partitions that faces the pressure chamber includes:
a first partition portion formed of only the first piezoelectric member; and
a second partition portion formed of the first piezoelectric member and the second piezoelectric member;
the pressure chamber is separated by the first partition portion on the front surface side;
the pressure chamber is separated by the second partition portion on a back surface side on which a liquid chamber configured to supply the liquid to the pressure chamber is formed; and
the electrode formed on at least one side surface of the first partition portion is formed within a range other than a predetermined range from the end surface.
